(19) United States
(12) Patent Application Publication
(10) Pub. No.: US 2017/0261890 A1
(43) Pub. Date: Sep. 14, 2017

(54) IMAGE FORMING APPARATUS AND METHOD OF CONTROLLING CONVEYANCE

(71) Applicant: Oki Data Corporation, Tokyo (JP)

(72) Inventors: Ryo TAKATSUKA, Tokyo (JP); Masakazu HIROI, Tokyo (JP)

(73) Assignee: Oki Data Corporation, Tokyo (JP)

(21) Appl. No.: 15/435,460

(22) Filed: Feb. 17, 2017

(30) Foreign Application Priority Data
Mar. 9, 2016 (JP) 2016-046064

(51) Int. Cl. G03G 15/00

(52) U.S. Cl. CPC G03G 15/1615

(57) ABSTRACT

An image forming apparatus includes a transfer belt, a medium conveyer, a controller, a transfer unit, and a first detector. The medium conveyer conveys a recording medium at a medium conveying speed. The controller sets the medium conveying speed to a first speed corresponding to a belt conveying speed in a first period, to a second speed lower than the first speed in a second period, to a third speed higher than the second speed and different from the first speed in a third period, and to the first speed in a fourth period. The transfer unit transfers the conveyed developer image onto the conveyed recording medium. The first detector performs detection of the recording medium in the first or second period. The controller sets a length of the third period on the basis of a result of the detection performed by the first detector.

### CROSS REFERENCE TO RELATED APPLICATIONS

The present application claims priority from Japanese Patent Application No. 2016-046064 filed on Mar. 9, 2016, the entire contents of which are hereby incorporated by reference.

### BACKGROUND

The technology relates to an image forming apparatus that forms an image, and to a method of controlling conveyance that is to be used by the image forming apparatus.

Image forming apparatuses may be classified into types such as a direct transfer type and an intermediate transfer type, for example. An image forming apparatus of the intermediate transfer type may have a configuration in which a toner image formed by an image forming unit is transferred onto an intermediate transfer belt, and the toner image on the intermediate transfer belt is transferred onto a recording medium thereafter, for example. The transferring of the toner image formed by the image forming unit onto the intermediate transfer belt may be referred to as a “primary transfer”. The transferring of the toner image on the intermediate transfer belt onto the recording medium may be referred to as a “secondary transfer”. For example, reference is made to Japanese Unexamined Patent Application Publication No. 2010-277038.

### SUMMARY

A stepper motor may be often used as a motor directed to conveyance of a recording medium in an image forming apparatus. Such a case may involve occurrence of a shift in a writing start position on a recording medium due to steps of the motor designed for control. The writing start position on the recording medium may refer to a position, on the recording medium, at which writing is started.

It is desirable to provide an image forming apparatus and a method of controlling conveyance that allow for suppression of a shift in a writing start position on a recording medium.

According to one embodiment of the technology, there is provided an image forming apparatus including a transfer belt, a medium conveyer, a controller, a transfer unit, and a first detector. The transfer belt conveys a developer image at a predetermined belt conveying speed. The medium conveyer conveys a recording medium along a conveying path at a medium conveying speed. The controller sets the medium conveying speed to a first speed in a first period, to a second speed in a second period that is after the first period, to a third speed in a third period that is after the second period, and to the first speed in a fourth period that is after the third period. The first speed corresponds to the belt conveying speed. The second speed is lower than the first speed. The third speed is higher than the second speed and different from the first speed. The transfer unit transfers the developer image conveyed by the transfer belt onto the recording medium conveyed by the medium conveyer. The first detector is provided upstream from the transfer unit in the conveying path. The first detector performs detection of the recording medium in one of the first period and the second period. The controller sets a length of the third period on a basis of a result of the detection performed by the first detector.

According to one embodiment of the technology, there is provided a method of controlling conveyance, the method including: conveying a developer image at a predetermined belt conveying speed using a transfer belt; setting a medium conveying speed at which a recording medium is conveyed to a first speed in a first period, to a second speed in a second period that is after the first period, to a third speed in a third period that is after the second period, and to the first speed in a fourth period that is after the third period, the first speed corresponding to the belt conveying speed, the second speed being lower than the first speed, the third speed being higher than the second speed and different from the first speed; conveying the recording medium along a conveying path at the medium conveying speed; performing, in one of the first period and the second period, detection of the recording medium conveyed along the conveying path; setting a length of the third period on a basis of a result of the detection of the recording medium; and transferring the developer image conveyed by the transfer belt onto the recording medium conveyed along the conveying path.

### BRIEF DESCRIPTION OF DRAWINGS

FIG. 1 is a configuration diagram illustrating an example of a configuration of an image forming apparatus according to a reference example.

FIG. 2 is a configuration diagram illustrating an example of a configuration of an image drum (ID) unit illustrated in FIG. 1.

FIG. 3 is a block diagram illustrating an example of the configuration of the image forming apparatus illustrated in FIG. 1.

FIG. 4 describes a relationship between a belt conveying speed and an engine speed.

FIG. 5 describes an example of a configuration of an acceleration-deceleration profile illustrated in FIG. 3.

FIG. 6 also describes an example of the configuration of the acceleration-deceleration profile illustrated in FIG. 3.

FIG. 7 describes an example of an operation of the image forming apparatus illustrated in FIG. 1.

FIG. 8 is a timing waveform chart illustrating an example of the operation of the image forming apparatus illustrated in FIG. 1.

FIG. 9 also describes an example of the operation of the image forming apparatus illustrated in FIG. 1.

FIG. 10 is a table describing an example of characteristics of the image forming apparatus illustrated in FIG. 1.

FIG. 11 describes an example of the characteristics of the image forming apparatus illustrated in FIG. 1.

FIG. 12 is a table describing an example of the characteristics of the image forming apparatus illustrated in FIG. 1.

FIG. 13 is a block diagram illustrating an example of a configuration of an image forming apparatus according to a first example embodiment.

FIG. 14 describes an example of an operation of the image forming apparatus illustrated in FIG. 13.

FIG. 15 is a timing waveform chart illustrating an example of the operation of the image forming apparatus illustrated in FIG. 13.

FIG. 16 is a flowchart illustrating an example of the operation of the image forming apparatus illustrated in FIG. 13.

FIG. 17 is a table describing an example of characteristics of the image forming apparatus illustrated in FIG. 13.

FIG. 18 is a configuration diagram illustrating an example of a configuration of an image forming apparatus according to a modification of the first example embodiment.

FIG. 19 is a block diagram illustrating an example of a configuration of an image forming apparatus according to a second example embodiment.

FIG. 20 describes a fine adjustment speed.

FIG. 21 describes an example of an operation of the image forming apparatus illustrated in FIG. 19.

FIG. 22 is a timing waveform chart illustrating an example of the operation of the image forming apparatus illustrated in FIG. 19.

FIG. 23 also describes an example of the operation of the image forming apparatus illustrated in FIG. 19.

FIG. 24 is another timing waveform chart illustrating an example of the operation of the image forming apparatus illustrated in FIG. 19.

FIG. 25A is a flowchart illustrating an example of the operation of the image forming apparatus illustrated in FIG. 19.

FIG. 25B is another flowchart illustrating an example of the operation of the image forming apparatus illustrated in FIG. 19.

FIG. 26 is a table describing an example of characteristics of the image forming apparatus illustrated in FIG. 19.

FIG. 27 is a configuration diagram illustrating an example of a configuration of an image forming apparatus according to a third example embodiment.

FIG. 28 is a block diagram illustrating an example of the configuration of the image forming apparatus illustrated in FIG. 27.

FIG. 29 describes an example of an operation of the image forming apparatus illustrated in FIG. 27.

FIG. 30 is a timing waveform chart illustrating an example of the operation of the image forming apparatus illustrated in FIG. 27.

FIG. 31 is a flowchart illustrating an example of the operation of the image forming apparatus illustrated in FIG. 27.

FIG. 32 is a timing waveform chart illustrating an example of an operation of an image forming apparatus according to a modification of the third example embodiment.

### DETAILED DESCRIPTION

Some example embodiments of the technology are described below in detail with reference to the drawings. The description is given in the following order.

1. Reference Example

2. First Example Embodiment

3. Second Example Embodiment

4. Third Example Embodiment

### 1. Reference Example

### Configuration Example

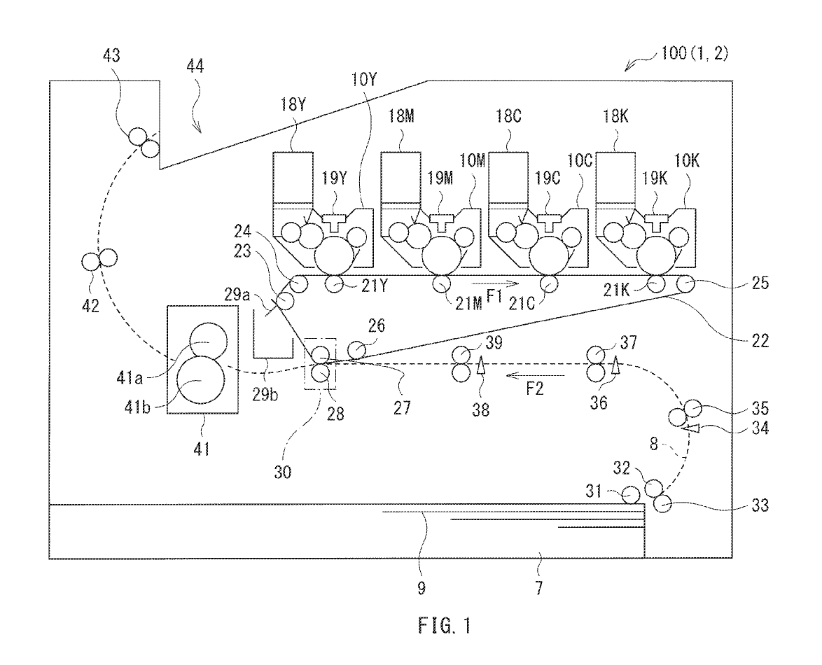

FIG. 1 illustrates an example of a configuration of an image forming apparatus (an image forming apparatus 100) according to a reference example. The image forming apparatus 100 may serve as a printer that forms an image on a recording medium by an electrophotographic method, for example. Non-limiting example of the recording medium may include plain paper.

The image forming apparatus 100 may include four image drum (ID) units 10 (10Y, 10M, 10C, and 10K), four toner containers 18 (18Y, 18M, 18C, and 18K), four light emitting diode (LED) heads 19 (19Y, 19M, 19C, and 19K), four primary transfer rollers 21 (21Y, 21M, 21C, and 21K), an intermediate transfer belt 22, a driving roller 23, driven rollers 24 to 26, a backup roller 27, a secondary transfer roller 28, a cleaning blade 29a, and a toner disposal box 29b, for example. The foregoing members may configure an image forming unit in the image forming apparatus 100.

The four ID units 10 may each form a toner image. Specifically, the ID unit 10Y may form a yellow (Y) toner image. The ID unit 10M may form a magenta (M) toner image. The ID unit 10C may form a cyan (C) toner image. The ID unit 10K may form a black (K) toner image. The ID units 10Y, 10M, 10C, and 10K may be disposed in order in a conveying direction F1 of the intermediate belt 22.

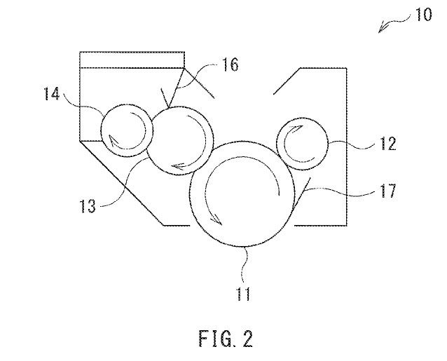

FIG. 2 illustrates an example of a configuration of the ID unit 10. The ID unit 10 may include a photosensitive drum 11, a cleaning blade 17, an electrically-charging roller 12, a developing roller 13, a developing blade 16, and a feeding roller 14, for example.

The photosensitive drum 11 may be a member that has a surface (a surficial part) supporting an electrostatic latent image. The photosensitive drum 11 may be rotated counterclockwise in the present example by power transmitted from a photosensitive drum motor 53 which will be described later. The photosensitive drum 11 may be electrically charged by the electrically-charging roller 12. The photosensitive drum 11 in the ID unit 10Y may be exposed by the LED head 19Y. The photosensitive drum 11 in the ID unit 10M may be exposed by the LED head 19M. The photosensitive drum 11 in the ID unit 10C may be exposed by the LED head 19C. The photosensitive drum 11 in the ID unit 10K may be exposed by the LED head 19K. The electrostatic latent image may be thus formed on the surface of each of the photosensitive drums 11. Further, each of the developing rollers 13 may feed the toner to the corresponding photosensitive drum 11. A toner image in accordance with the electrostatic latent image may be thereby formed (developed) on each of the photosensitive drums 11.

The cleaning blade 17 may be a member that scrapes the toner remained on the surface (the surficial part) of the photosensitive drum 11 to clean the surface (the surficial part) of the photosensitive drum 11. The cleaning blade 17 may be so provided as to be in contact with the surface of the photosensitive drum 11 in a counter direction. In other words, the cleaning blade 17 may be so provided as to protrude in a direction opposite to a rotation direction of the photosensitive drum 11. The cleaning blade 17 may be also pressed against the photosensitive drum 11 by a predetermined pressing amount.

The electrically-charging roller 12 may be a member that electrically charges the surface (the surficial part) of the photosensitive drum 11. The electrically-charging roller 12 may be so provided as to be in contact with a surface (a peripheral surface) of the photosensitive drum 11, and as to be pressed against the photosensitive drum 11 by a predetermined pressing amount. The electrically-charging roller 12 may be rotated clockwise in the present example, in accordance with rotation of the photosensitive drum 11. The electrically-charging roller 12 may receive a predetermined voltage from a high voltage power source 52 which will be described later.

The developing roller 13 may be a member having a surface that supports toner that is electrically charged by a negative voltage. The developing roller 13 may be so provided as to be in contact with the surface (the peripheral surface) of the photosensitive drum 11, and as to be pressed against the photosensitive drum 11 by a predetermined pressing amount. The developing roller 13 may be rotated clockwise in the present example by power transmitted from the photosensitive drum motor 53 which will be described later. The developing roller 13 may receive a predetermined voltage from the high voltage power source 52 which will be described later.

The developing blade 16 may be a member that is in contact with a surface of the developing roller 13, thereby forming a layer made of the toner (a toner layer) on the surface of the developing roller 13 and regulating (controlling or adjusting) thickness of the toner layer to be formed. The developing blade 16 may be a plate-shaped elastic member that is made of a material such as stainless steel and bended to form a shape of the letter “L”, for example. The developing blade 16 may be so provided that the bended part of the developing blade 16 is in contact with the surface of the developing roller 13, and that the developing blade 16 is pressed against the developing roller 13 by a predetermined pressing amount.

The feeding roller 14 may be a member that feeds the toner stored in the toner container 18 to the developing roller 13. Specifically, in the ID unit 10Y, the feeding roller 14 may feed the toner stored in the toner container 18Y to the developing roller 13. In the ID unit 10M, the feeding roller 14 may feed the toner stored in the toner container 18M to the developing roller 13. In the ID unit 10C, the feeding roller 14 may feed the toner stored in the toner container 18C to the developing roller 13. In the ID unit 10K, the feeding roller 14 may feed the toner stored in the toner container 18K to the developing roller 13. The feeding roller 14 may be so provided as to be in contact with a surface (a peripheral surface) of the developing roller 13, and as to be pressed against the developing roller 13 by a predetermined pressing amount. The feeding roller 14 may be rotated clockwise in the present example by power transmitted from the photosensitive drum motor 53 which will be described later. This may generate friction between a surface of the feeding roller 14 and the surface of the developing roller 13 in each of the ID units 10. Accordingly, the toner may be electrically charged due to so-called triboelectric charging in each of the ID units 10. The feeding roller 14 may receive a predetermined voltage from a high voltage power source 52 which will be described later.

The four toner containers 18 illustrated in FIG. 1 each may store the toner. Specifically, the toner container 18Y may store yellow (Y) toner. The toner container 18M may store magenta (M) toner. The toner container 18C may store cyan (C) toner. The toner container 18K may store black (K) toner.

The four LED heads 19 may be members that irradiate the respective photosensitive drums 11 in the four ID units 10 with light. Specifically, the LED head 19Y may irradiate the photosensitive drum 11 in the ID unit 10Y with light. The LED head 19M may irradiate the photosensitive drum 11 in the ID unit 10M with light. The LED head 19C may irradiate the photosensitive drum 11 in the ID unit 10C with light. The LED head 19K may irradiate the photosensitive drum 11 in the ID unit 10K with light. Each of the foregoing photosensitive drums 11 may be thus exposed by corresponding one of the LED heads 19. The electrostatic latent image may be thus formed on the surface of each of the photosensitive drums 11.

The four primary transfer rollers 21 may be members that electrostatically transfer the respective toner images formed by the four ID units 10 onto a transfer surface of the intermediate transfer belt 22. The transfer surface of the intermediate transfer belt 22 may be a surface onto which an image is to be transferred. The primary transfer roller 21Y may face the photosensitive drum 11 in the ID unit 10Y with the intermediate transfer belt 22 in between. The primary transfer roller 21M may face the photosensitive drum 11 in the ID unit 10M with the intermediate transfer belt 22 in between. The primary transfer roller 21C may face the photosensitive drum 11 in the ID unit 10C with the intermediate transfer belt 22 in between. The primary transfer roller 21K may face the photosensitive drum 11 in the ID unit 10K with the intermediate transfer belt 22 in between. The primary transfer rollers 21 may each receive a predetermined voltage from the high voltage power source 52 which will be described later. The image forming apparatus 100 may thus have the configuration in which the toner images formed by the respective ID units 10 are transferred onto the transfer surface of the intermediate transfer belt 22. The transfer of the toner images formed by the respective ID units 10 onto the transfer surface of the intermediate transfer belt 22 may be referred to as the primary transfer.

The intermediate transfer belt 22 may be an endless elastic belt. The intermediate transfer belt 22 may be stretched by the driving roller 23, the driven rollers 24 to 26, and the backup roller 27. In other words, the intermediate transfer belt 22 may lie from the driving roller 23, to the driven rollers 24 to 26, and to the backup roller 27 while being stretched. The intermediate transfer belt 22 may be rotated circularly in the conveying direction F1 in accordance with rotation of the driving roller 23. Upon rotating in such a manner, the intermediate transfer belt 22 may travel between the ID unit 10Y and the primary transfer roller 21Y, between the ID unit 10M and the primary transfer roller 21M, between the ID unit 10C and the primary transfer roller 21C, between the ID unit 10K and the primary transfer roller 21K, and between the backup roller 27 and the secondary transfer roller 28.

The driving roller 23 may be a member that circularly rotates the intermediate transfer belt 22. In the present example, the driving roller 23 may be provided upstream from the four ID units 10 in the conveying direction F1. The driving roller 23 may be rotated clockwise in the present example by power transmitted from a belt motor 54 which will be described later. The driving roller 23 may thus rotate the intermediate transfer belt 22 circularly in the conveying direction F1.

The driven rollers 24 to 26 each may be a member that is rotated clockwise in the present example in accordance with the circular rotation of the intermediate transfer belt 22. The driven roller 24 may be provided upstream from the four ID units 10 in the conveying direction F1. The driven roller 25 may be provided downstream from the four ID units 10 in the conveying direction F1. The driven roller 26 may be provided between the driven roller 25 and the backup roller 27.

The backup roller 27 may be a member that is rotated clockwise in the present example in accordance with the circular rotation of the intermediate transfer belt 22. The backup roller 27 may face the secondary transfer roller 28 with a conveying path 8 and the intermediate transfer belt 22 in between. The conveying path 8 may be a path along which the recording medium 9 is conveyed. The backup roller 27 may configure a secondary transfer unit 30 together with the secondary transfer roller 28. The backup roller 27 may receive a predetermined voltage from the high voltage power source 52 which will be described later.

The secondary transfer roller 28 may be a member that transfers the toner image on the transfer surface of the intermediate transfer belt 22 onto a transfer surface of the recording medium 9. The transfer surface of the recording medium 9 may be a surface onto which an image is to be transferred. The secondary transfer roller 28 may face the backup roller 27 with the conveying path 8 and the intermediate transfer belt 22 in between. The secondary transfer roller 28 may configure the secondary transfer unit 30 together with the backup roller 27. The secondary transfer roller 28 may receive a predetermined voltage from the high voltage power source 52 which will be described later. The image forming apparatus 100 may thus have the configuration in which the toner image on the transfer surface of the intermediate transfer belt 22 is transferred onto the transfer surface of the recording medium 9. The transfer of the toner image on the transfer surface of the intermediate transfer belt 22 onto the transfer surface of the recording medium 9 may be referred to as the secondary transfer.

The cleaning blade 29a may be a member that scrapes a substance attached onto the transfer surface of the intermediate transfer belt 22 off to clean the transfer surface of the intermediate transfer belt 22. Non-limiting example of the substance attached onto the transfer surface of the intermediate transfer belt 22 may include the toner. The cleaning blade 29a may be so provided in a position that faces the driving roller 23 as to be in contact with the transfer surface of the intermediate transfer belt 22. The toner disposal box 29b may be a member that contains the substance scraped off by the cleaning blade 29a.

The image forming apparatus 100 may further include a pickup roller 31, a medium feeding roller 32, a separating roller 33, a resist sensor 34, a resist roller 35, a conveyance sensor 36, a conveying roller 27, a conveyance sensor 38, a conveying roller 39, a fixing unit 41, a conveying roller 42, and a discharging roller 43. The foregoing members may be disposed along the conveying path 8 along which the recording medium 9 is conveyed.

The pickup roller 31 may be a member that picks up the recording medium 9 from a medium tray 7. The pickup roller 31 may be rotated by power transmitted from a motor 55 via a clutch 56. The motor 55 and the clutch 56 will be described later.

The medium feeding roller 32 and the separating roller 33 each may be a member that feeds the recording medium 9 picked up by the pickup roller 31 to the conveying path 8. The medium feeding roller 32 and the separating roller 33 may face each other with the conveying path 8 in between. The medium feeding roller 32 may be rotated by power transmitted from the motor 55 via the clutch 56. The motor 55 and the clutch 56 will be described later. The separating roller 33 may provide the recording medium 9 with force in a direction opposite from the conveying direction F2. The medium feeding roller 32 and the separating roller 33 may thus feed the recording medium 9 one by one to the conveying path 8.

The resist sensor 34 may detect passage of the recording medium 9 in the conveying path 8. The resist sensor 34 may be provided between a location at which the medium feeding roller 32 and the separating roller 33 are provided and a location at which the resist roller 35 is provided.

The resist roller 35 may be a pair of rollers that sandwich the conveying path 8 in between. The resist roller 35 may be a member that corrects a skew of the recording medium traveling along the conveying path 8. The resist roller 35 may be rotated by power transmitted from the motor 55 via a clutch 57. The motor 55 and the clutch 57 will be described later.

The conveyance sensor 36 may detect passage of the recording medium 9 in the conveying path 8. The conveyance sensor 36 may be provided upstream from the secondary transfer unit 30, and between the resist roller 35 and the conveying roller 37. The conveyance sensor 36 may be used to adjust a shift in the writing start position on the recording medium 9 upon transfer of the toner image onto the recording medium 9 performed by the secondary transfer unit 30, which will be described later.

The conveying roller 37 may be a pair of rollers that sandwich the conveying path 8 in between. The conveying roller 37 may be a member that conveys the recording medium 9 along the conveying path 8. The conveying roller 37 may be rotated by power transmitted from a conveying motor 58 which will be described later.

The conveyance sensor 38 may detect passage of the recording medium 9 in the conveying path 8. The conveyance sensor 38 may be provided upstream from the secondary transfer unit 30, and between the conveying roller 37 and the conveying roller 39. As with the conveyance sensor 36, the conveyance sensor 38 may be used to adjust the shift in the writing start position on the recording medium 9 upon the transfer of the toner image onto the recording medium 9 performed by the secondary transfer unit 30.

The conveying roller 39 may be a pair of rollers that sandwich the conveying path 8 in between. The conveying roller 39 may be a member that feeds the recording medium 9 to the secondary transfer unit 30 along the conveying path 8. The conveying roller 39 may be rotated by power transmitted from the conveying motor 58 which will be described later.

The secondary transfer unit 30 may perform secondary transfer of the toner image formed on the transfer surface of the intermediate transfer belt 22 onto the transfer surface of the recording medium 9.

The fixing unit 41 may be a member that applies heat and pressure onto the recording medium 9 fed from the secondary transfer unit 30 and thereby fix, onto the recording medium 9, the toner image that has been transferred onto the recording medium 9. The fixing unit 41 may include a heating roller 41a and a pressurizing roller 41b. The heating roller 41a may include a heater. The heater may be a halogen lamp, for example. The heating roller 41a may be a member that applies heat on the toner on the recording medium 9. The pressurizing roller 41b may be so provided as to provide a pressure contact portion between the heating roller 41a and the pressurizing roller 41b. The pressurizing roller 41b may be a member that applies pressure on the toner on the recording medium 9. The fixing unit 41 may thus heat, melt, and pressurize the toner on the recording medium 9. As a result, the toner image may be fixed onto the recording medium 9.

The conveying roller 42 may be a pair of rollers that sandwich the conveying path 8 in between. The conveying roller 42 may be a member that conveys, along the conveying path 8, the recording medium 9 fed from the fixing unit 41. The conveying roller 42 may be rotated by power transmitted from a motor 59 which will be described later.

The discharging roller 43 may be a pair of rollers that sandwich the conveying path 8 in between. The discharging roller 43 may be a member that guides the recording medium 9 to outside of the image forming apparatus 100 to discharge the recording medium 9 to a discharging tray 44. The discharging roller 43 may be rotated by power transmitted from the motor 59 which will be described later.

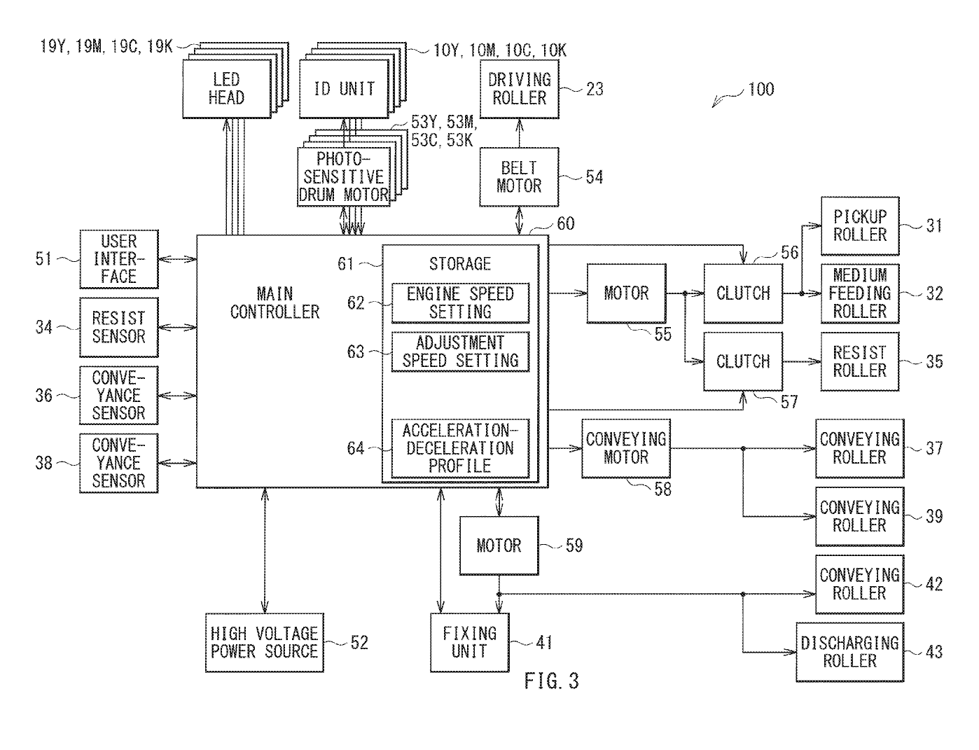

FIG. 3 illustrates an example of a control mechanism in the image forming apparatus 100. The image forming apparatus 100 may include a user interface 51, the high voltage power source 52, the four photosensitive drum motors 53 (53Y, 53M, 53C, and 53K), the belt motor 54, the motor 55, the clutches 56 and 57, the conveying motor 58, the motor 59, and a main controller 60.

The user interface 51 may include a liquid crystal display panel, a touch panel, various buttons, and any other component, for example. The user interface 51 may receive an operation performed by a user and transmit the contents of the operation to the main controller 60. Further, the user interface 51 may display an operation state of the image forming apparatus 100 with respect to the user on the basis of instructions from the main controller 60.

The high voltage power source 52 may supply, at a predetermined timing, a predetermined voltage to each of the members such as the electrically-charging rollers 12, the developing rollers 13, and the feeding rollers 14 in the respective ID units 10, the four primary transfer rollers 21, the backup roller 27, and the secondary transfer roller 28.

The four photosensitive drum motors 53 each may generate, on the basis of the instructions from the main controller 60, power to be supplied to corresponding one of the four ID units 10. Specifically, the photosensitive drum motor 53Y may generate power to be supplied to the ID unit 10Y. The photosensitive drum motor 53M may generate power to be supplied to the ID unit 10M. The photosensitive drum motor 53C may generate power to be supplied to the ID unit 10C. The photosensitive drum motor 53K may generate power to be supplied to the ID unit 10K.

The belt motor 54 may generate, on the basis of the instructions from the main controller 60, power to be supplied to the driving roller 23 that drives the intermediate transfer belt 22. The belt motor 54 may include a brushless direct current (DC) motor, for example.

The motor 55 may generate, on the basis of the instructions from the main controller 60, power to be supplied to the pickup roller 31, the medium feeding roller 32, and the resist roller 35. The motor 55 may include a pulse motor (a stepper motor) that operates in synchronization with a pulse signal, for example.

The clutch 56 may engage the power generated by the motor 55 to the pickup roller 31 and the medium feeding roller 32, or disengage the power, on the basis of the instructions from the main controller 60. The clutch 57 may engage the power generated by the motor 55 to the resist roller 35, or disengage the power, on the basis of the instructions from the main controller 60.

The conveying motor 58 may generate, on the basis of the instructions from the main controller 60, power to be supplied to the conveying rollers 37 and 39. The conveying motor 58 may include a pulse motor that operates in synchronization with a pulse signal, for example. Non-limiting example of the pulse motor may include a stepper motor.

The motor 59 may generate, on the basis of the instructions from the main controller 60, power to be supplied to the fixing unit 41, the conveying roller 42, and the discharging roller 43.

The main controller 60 may control an operation of the image forming apparatus 100. The main controller 60 may include a central processing unit (CPU), a random access memory (RAM), a read only memory (ROM), and any other component, for example. The main controller 60 may operate on the basis of a program. Specifically, the main controller 60 may be coupled, via an input-output port, to the four LED heads 19, the user interface 51, the high voltage power source 52, the four photosensitive drum motors 53, the belt motor 54, the motor 55, the clutches 56 and 57, the conveying motor 58, the motor 59, and the fixing unit 41, and control an operation of each of the foregoing members. The main controller 60 may also be coupled, via the input-output port, to the resist sensor 34 and the conveyance sensors 36 and 38. The main controller 60 may adjust, on the basis of results of the detection performed by the respective conveyance sensors 36 and 38, the shift in the writing start position upon the transfer of the toner image onto the recording medium 9 performed by the secondary transfer unit 30.

The main controller 60 may include a storage 61. The storage 61 may include a non-volatile memory, for example. The storage 61 may store a printing condition, various settings, and any other information, for example. In the present example, the storage 61 may include an engine speed setting 62, an adjustment speed setting 63, and an acceleration-deceleration profile 64, for example. The engine speed setting 62, the adjustment speed setting 63, and the acceleration-deceleration profile 64 may be used upon setting of a medium conveying speed V of the recording medium 9 which is performed through controlling of the conveying motor 58. Specifically, the stepper motor operates in synchronization with the pulse signal, and has a fixed rotation angle per pulse. Accordingly, the main controller 60 may supply the pulse to the conveying motor 58 on the basis of the engine speed setting 62, the adjustment speed setting 63, and the acceleration-deceleration profile 64, and thereby set the medium conveying speed V.

The engine speed setting 62 may be setting data that is directed to setting the medium conveying speed V to an engine speed Vf. Specifically, the engine speed setting 62 may include a setting value of a pulse width of the pulse signal to be supplied to the conveying motor 58 upon the setting of the medium conveying speed V to the engine speed Vf. The engine speed Vf may correspond to a belt conveying speed Vb at which the intermediate transfer belt 22 is conveyed.

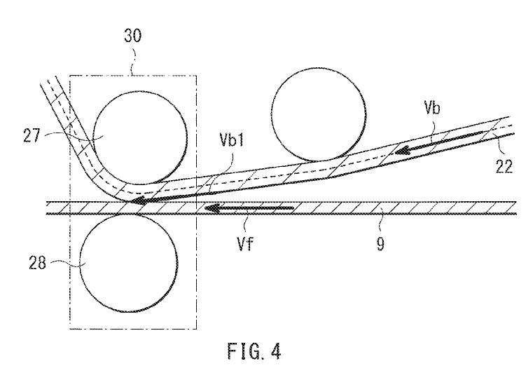

FIG. 4 illustrates a relationship between the engine speed Vf and the belt conveying speed Vb. It is to be noted that FIG. 4 exaggerates the thickness of the intermediate transfer belt 22 for the sake of convenience in description. The intermediate transfer belt 22 may be wound along an outer periphery of the backup roller 27 in the secondary transfer unit 30. A speed Vb1 of a surface, of the intermediate transfer belt 22, that is to be brought into contact with the recording medium 9 may be therefore slightly higher than the belt conveying speed Vb depending on the thickness of the intermediate transfer belt 22 (Vb1>Vb). The main controller 60 may so perform a control that the speed Vb1 is equal to the engine speed Vf, when the secondary transfer unit 30 transfers the toner image on the intermediate transfer belt 22 onto the recording medium 9. Accordingly, the engine speed Vf may be set to a speed that is slightly higher than the belt conveying speed Vb (Vf>Vb).

The adjustment speed setting 63 may be setting data directed to setting the medium conveying speed V to an adjustment speed Vs. Specifically, the adjustment speed setting 63 may include a setting value of a pulse width of the pulse signal to be supplied to the conveying motor 58 upon the setting of the medium conveying speed V to the adjustment speeding speed Vs. The adjustment speed Vs may be lower than the engine speed Vf.

The acceleration-deceleration profile 64 may be used upon changing of the medium conveying speed V. The main controller 60 may gradually change the pulse width of the pulse signal to be supplied to the conveying motor 58 upon changing the medium conveying speed V. The conveying motor 58 may be a stepper motor, for example. The acceleration-deceleration profile 64 may include a setting value of a pulse width of the pulse signal to be supplied to the conveying motor 58 at a time when the medium conveying speed V is gradually changed.

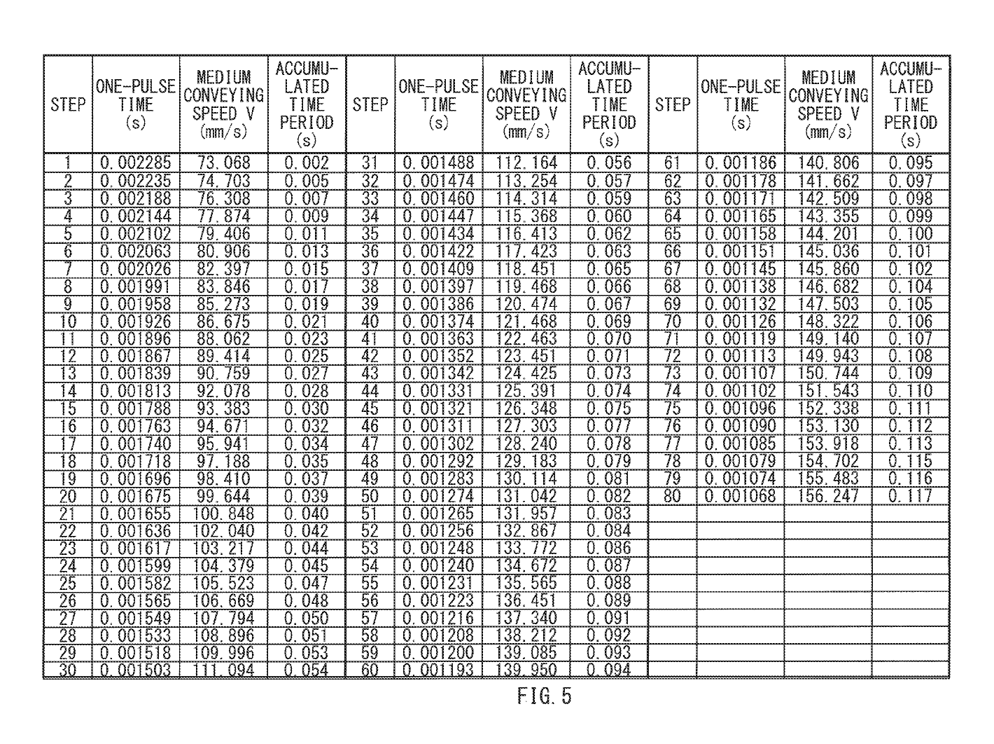

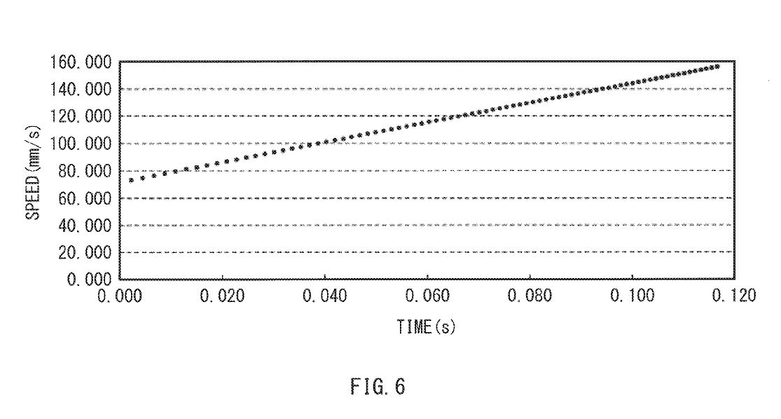

FIG. 5 illustrates an example of the acceleration-deceleration profile 64. FIG. 6 illustrates a plot of the acceleration-deceleration profile 64. FIGS. 5 and 6 illustrate an example of the acceleration-deceleration profile 64 in a case of increasing the medium conveying speed V, i.e., a case of accelerating the medium conveying speed V. It is to be noted that the acceleration-deceleration profile 64 may be applicable, by inverting the time axis, to a case of decreasing the medium conveying speed V, i.e., a case of decelerating the medium conveying speed V. Alternatively, a partial range of the acceleration-deceleration profile 64 may be used upon the changing of the medium conveying speed V. With the use of the acceleration-deceleration profile 64, the main controller 60 may be able to change the medium conveying speed V from one speed to another speed. The foregoing “one speed” and the foregoing “another speed” may be any speed.

It is to be noted that the conveying rollers 37 and 39 each may be coupled to the conveying motor 58 via a gear train, in general. The medium conveying speed V may therefore depend on a gear ratio of the gear train. Further, the medium conveying speed V may also depend on roller diameters of the conveying rollers 37 and 39, for example. In the following description, the rotation speed of the conveying motor 58 and the medium conveying speed V are assumed to be equivalent to each other for the sake of convenience in description. The same is applicable to the relationship between the rotation speed of the belt motor 54 and the conveying speed of the intermediate transfer belt 22.

The main controller 60 may control, on the basis of the results of the detection performed by the conveyance sensors 36 and 38, the medium conveying speed V, with the engine speed setting 62, the adjustment speed setting 63, and the acceleration-deceleration profile 64 described above. Specifically, the main controller 60 may set the medium conveying speed V to the engine speed Vf and thereby cause the recording medium 9 to be conveyed along the conveying path 8 as will be described later. Upon the conveying of the recording medium 9, the main controller 60 may so cause the recording medium 9 to be conveyed that the recording medium 9 precedes the toner image on the intermediate transfer belt 22 by a predetermined distance. The predetermined distance may be an adjustment distance D, for example. Thereafter, the main controller 60 may change (decelerate) the medium conveying speed V to the adjustment speed Vs on the basis of the result of the detection performed by the first conveyance sensor 36, and change (accelerate) the medium conveying speed V to the engine speed Vf on the basis of the result of the detection performed by the second conveyance sensor 38. The main controller 60 may thus set the medium conveying speed V to the adjustment speed Vs for a predetermined period. The main controller 60 may thereby adjust the shift in the writing start position on the recording medium 9 upon the transfer of the toner image onto the recording medium 9 performed by the secondary transfer unit 30.

### [Operation and Workings]

The operation and workings of the image forming apparatus 100 according to the reference example are described below.

### [Outline of Overall Operation]

Referring to FIGS. 1 to 3, an outline of an overall operation of the image forming apparatus 100 is described below. In the image forming apparatus 100, upon reception of print data, the main controller 60 may first control the fixing unit 41, and thereby cause the heater in the heating roller 41a to operate. When the temperature of the heating roller 41a reaches a predetermined temperature, the main controller 60 may control the respective photosensitive drum motors 53, and thereby cause the respective ID units 10 to operate. The main controller 60 may also control the belt motor 54, and thereby set the conveying speed of the intermediate transfer belt 22 to the belt conveying speed Vb. The main controller 60 may also control the high voltage power source 52 and thereby supply, at the predetermined timing, the predetermined voltage to each of the rollers such as the electrically-charging rollers 12, the developing rollers 13, and the feeding rollers 14 in the respective ID units 10, the four primary transfer rollers 21, the backup roller 27, and the secondary transfer roller 28.

The main controller 60 may control the respective LED heads 19, and thereby cause the photosensitive drums 11 of the respective ID units 10 to be exposed. The electrostatic latent image may be thus formed on the surface of each of the photosensitive drums 11. The toner electrically charged on each of the developing rollers 13 may be fed to the corresponding photosensitive drum 11 by Coulomb force. This may result in development of the toner image as a visible image on each of the photosensitive drums 11. The primary transfer of the toner image formed on each of the photosensitive drums 11 onto the transfer surface of the intermediate transfer belt 22 may be performed. The toner image on the intermediate transfer belt 22 may be conveyed in the conveying direction F1 at the belt conveying speed Vb to be fed to the secondary transfer unit 30.

The main controller 60 may control the motor 55, the conveying motor 58, and the motor 59, and thereby cause the recording medium 9 to be conveyed along the conveying path 8. The main controller 60 may control the conveying motor 58, and thereby first set the medium conveying speed V of the recording medium 9 to the engine speed Vf. Upon the setting of the medium conveying speed V to the engine speed Vf, the main controller 60 may cause the recording medium 9 to precede the toner image on the intermediate transfer belt 22 by the adjustment distance D. Thereafter, the main controller 60 may change (decelerate) the medium conveying speed V to the adjustment speed Vs on the basis of the result of the detection performed by the first conveyance sensor 36, and change (accelerate) the medium conveying speed V to the engine speed Vf on the basis of the result of the detection performed by the second conveyance sensor 38. The main controller 60 may thus set the medium conveying speed V to the adjustment speed Vs for a predetermined period. The main controller 60 may thereby adjust the shift in the writing start position on the recording medium 9 upon the transfer of the toner image onto the recording medium 9 performed by the secondary transfer unit 30.

The secondary transfer unit 30 may perform secondary transfer of the toner image formed on the transfer surface of the intermediate transfer belt 22 onto the transfer surface of the recording medium 9. The fixing unit 41 may apply heat and pressure onto the recording medium 9 fed from the secondary transfer unit 30, and thereby fix, onto the recording medium 9, the toner image transferred onto the recording medium 9. The recording medium 9 on which the toner image is fixed may be guided to the outside of the image forming apparatus 100.

### [Detailed Operation]

The image forming apparatus 100 may asynchronously or semisynchronously perform an image forming operation and an operation of conveying the recording medium 9 from the medium tray 7. The image forming apparatus 100 may so perform a conveyance control of the recording medium 9 that a position of the toner image on the intermediate transfer belt 22 is consistent with a corresponding position in the recording medium 9 in the secondary transfer unit 30.

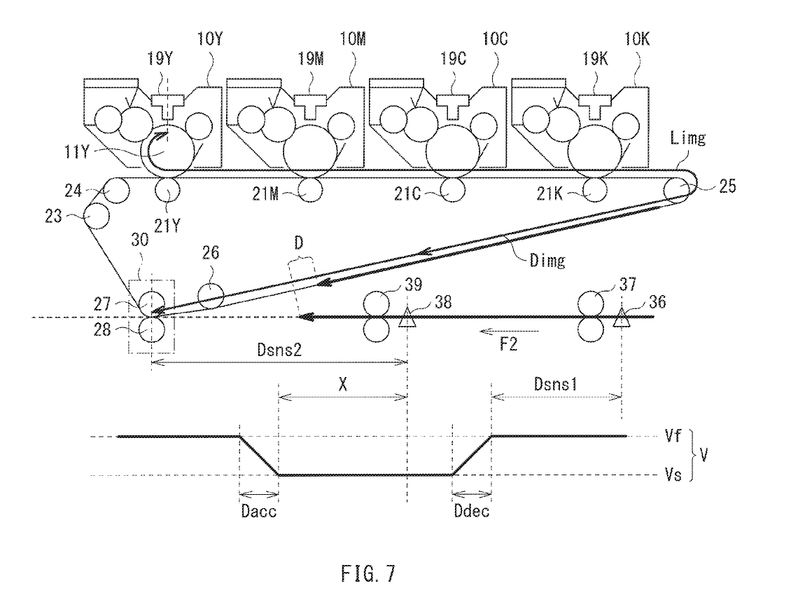

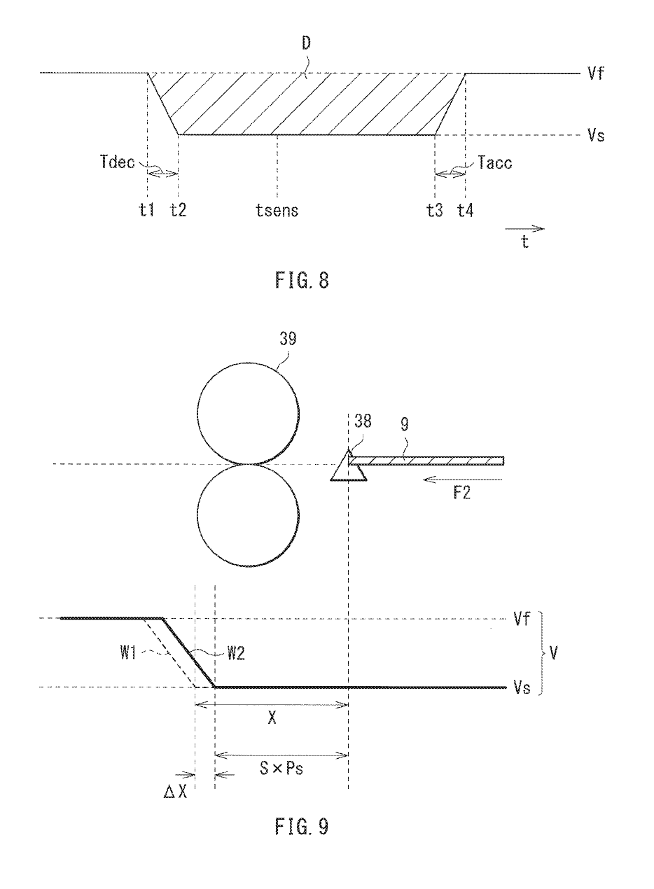

FIG. 7 illustrates an example of the conveyance control of the recording medium 9. FIG. 8 illustrates an example of a change in the medium conveying speed V on a time axis. In FIGS. 7 and 8, a distance Limg may be a distance from an exposure position of the photosensitive drum 11 (11Y) in the ID unit 10Y to the secondary transfer roller 28 in the secondary transfer unit 30. A toner image conveyance distance Dimg may be a distance by which the toner image is conveyed from the exposure position of the photosensitive drum 11Y in the ID unit 10Y at a time when the second conveyance sensor 38 detects a tip end of the recording medium 9. A distance Dsns1 may be a distance by which the recording medium 9 travels from a time when the first conveyance sensor 36 detects the tip end of the recording medium 9 to a time when the change (the deceleration) of the medium conveying speed V from the engine speed Vf toward the adjustment speed Vs is started. A distance Dsns2 may be a distance from the second conveyance sensor 38 to the secondary transfer roller 28 in the secondary transfer unit 30. A deceleration distance Ddec may be a distance by which the recording medium 9 travels from a time when the change (the deceleration) of the medium conveying speed V from the engine speed Vf toward the adjustment speed Vs is started to a time when the foregoing change is completed. A deceleration time period Tdec may be a time period from the time when the change (the deceleration) of the medium conveying speed V from the engine speed Vf toward the adjustment speed Vs is started to the time when the foregoing change is completed. An acceleration distance Dacc may be a distance by which the recording medium 9 travels from a time when the change (the acceleration) of the medium conveying speed V from the adjustment speed Vs toward the engine speed Vf is started to a time when the foregoing change is completed. An acceleration time period Tacc may be a time period from the time when the change (the acceleration) of the medium conveying speed V from the adjustment speed Vs toward the engine speed Vf is started to the time when the foregoing change is completed. A distance X may be a distance by which the recording medium 9 travels from a time when the conveyance sensor 38 detects the tip end of the recording medium 9 to the time when the change (the acceleration) of the medium conveying speed V from the adjustment speed Vs to the engine speed Vf is started.

As schematically illustrated in FIG. 7, the image forming apparatus 100 may first cause the recording medium 9 to precede the toner image on the intermediate transfer belt 22 by the adjustment distance D. Specifically, the main controller 60 may adjust ON-timings of the respective clutches 56 and 57, and thereby adjust the adjustment distance D, for example. When the adjustment distance D is excessively short, an adjustment range may be narrowed. When the adjustment distance D is excessively long, print throughput may be decreased. Specifically, when the adjustment distance D is long, it may be necessary to widen an interval between a plurality of recording media 9 in accordance with the adjustment distance D upon successive printing on the recording media 9, decreasing the print throughput. Accordingly, it is preferable to set the adjustment distance D to be in a range from about 15 mm to about 35 mm both inclusive, for example.

Referring to FIGS. 7 and 8, the main controller 60 may control the conveying motor 58 and thereby start to change (to decelerate) the medium conveying speed V of the recording medium 9 from the engine speed Vf toward the adjustment speed Vs at timing t1. The timing t1 may be timing when the recording medium 9 has traveled by the distance Dsns1 after the first conveyance sensor 36 has detected the tip end of the recording medium 9. Thereafter, the medium conveying speed V may reach the adjustment speed Vs at timing t2.

Thereafter, the second conveyance sensor 38 may detect the tip end of the recording medium 9 at a detection timing tsens in a period in which the recording medium 9 is conveyed at the adjustment speed Vs. The main controller 60 may determine the distance X on the basis of the toner image conveyance distance Dimg at the detection timing tsens. Further, the main controller 60 may control the conveying motor 58 and thereby start to change (to accelerate) the medium conveying speed V of the recording medium 9 from the adjustment speed Vs toward the engine speed Vf at timing t3. The timing t3 may be timing when the recording medium 9 has traveled by the distance X after the second conveyance sensor 38 has detected the tip end of the recording medium 9. Thereafter, the medium conveying speed V may reach the engine speed Vf at timing t4.

The main controller 60 may thus cause the position of the toner image on the intermediate transfer belt 22 and the corresponding position of the recording medium 9 to be coincident with each other in the secondary transfer unit 30. In other words, the adjustment distance D may correspond to the area of the hatched part in FIG. 8.

In order to cause the position of the toner image on the intermediate transfer belt 22 and the corresponding position of the recording medium 9 to be coincident with each other in the secondary transfer unit 30, it may be necessary to satisfy the following expression (E1).

$$\frac{Limg - Dimg}{Vb} = \frac{X}{Vs} + Tacc + \frac{Dsns 2 - X - Dacc}{Vf} \qquad ( E1 )$$

The left side of the expression (E1) expresses a time period from a time when the second conveyance sensor 38 detects the tip end of the recording medium 9 to a time when the toner image on the intermediate transfer belt 22 arrives at the secondary transfer roller 28. The right side of the expression (E1) expresses a time period from a time when the second conveyance sensor 38 detects the tip end of the recording medium 9 to a time when the recording medium 9 arrives at the secondary transfer roller 28. The following expression is obtained by solving the expression (E1) for the distance X.

$$X = {C}_{1} \times ( Limg - Dimg ) + {C}_{2} \\ \{ \begin{matrix}{C}_{1} = \frac{Vf \times Vs}{Vb \times ( Vf - Vs )} \\ {C}_{2} = \frac{Vf \times Vs \times Tacc + Vs \times ( Dsns 2 - Dacc )}{Vs - Vf}\end{matrix} \qquad ( E2 )$$

The toner image conveyance distance Dimg may be determined with the number of pulses supplied to the belt motor 54 and an amount by which the intermediate transfer belt 22 is conveyed per pulse for a period from a time when the LED head 19Y starts emitting light to a time when the second conveyance sensor 38 detects the tip end of the recording medium 9. The main controller 60 may determine the distance X using the foregoing expression (E2). The main controller 60 may control the conveying motor 58, and thereby start to change (to accelerate) the medium conveying speed V of the recording medium 9 from the adjustment speed Vs toward the engine speed Vf, when the recording medium 9 travels by the distance X after the second conveyance sensor 38 has detected the tip end of the recording medium 9.

The conveying motor 58 may be a stepper motor. This may cause occurrence of a shift (a shift amount ΔX) in distance when an attempt is made to cause the recording medium 9 to travel by the distance X. In other words, the main controller 60 may supply the conveying motor 58 with pulses of the pulse number Ps in order to cause the recording medium 9 to travel by the distance X. The pulse number Ps which is the number of pulses may be expressed by the following expression (E3), for example,

$$Ps = int ( \frac{X}{S} ) \qquad ( E3 )$$

where S is a medium conveyance amount of the recording medium 9 per pulse to be supplied to the conveying motor 58. The medium conveyance amount of the recording medium 9 may be an amount by which the recording medium 9 is conveyed. “int” is a function that performs a calculation of rounding down to the whole number. Accordingly, the shift amount ΔX may be expressed as the following expression.

ΔX=Δ−S×Ps (0<Δx<S) (E4)

FIG. 9 illustrates an example of the shift in the distance X. The characteristics W1 indicate an ideal case and the characteristics W2 indicate an actual case in FIG. 9. As illustrated in FIG. 9, when an attempt is made to accelerate, as indicated by the characteristics W1, the recording medium 9 when the recording medium 9 travels by the distance X after the second conveyance sensor 38 has detected the tip end of the recording medium 9, a shift in the distance X as indicated by the characteristics W2 may occur. Specifically, the actual distance X may be shorter than the ideal distance due to the calculation of rounding down to the whole number as expressed by the expression (E3) in the present example.

A time difference Δt may occur between the ideal case and the actual case in the time period from the time when the second conveyance sensor 38 detects the tip end of the recording medium 9 to the time when the conveying motor 58 starts acceleration. The time difference Δt may be expressed by the following expression (E5).

$$Δ t = \frac{Δ X}{Vs} - \frac{Δ X}{Vf} \qquad ( E5 )$$

Specifically, due to the shift in the distance X, a distance by which the recording medium 9 is conveyed at the adjustment speed Vs becomes shorter whereas a distance by which the recording medium 9 is conveyed at the engine speed Vf becomes longer. This may cause the time difference Δt to occur. The toner image on the intermediate transfer belt 22 may travel in the time difference Δt. This may cause the shift in the writing start position on the recording medium 9 to occur. A shift amount G of the writing start position which is an amount of a shift in the writing start position on the recording medium 9 may be expressed by the following expression (E6).

$$G = Vb \times Δ t = Vb \times ( \frac{Δ X}{Vs} - \frac{Δ X}{Vf} ) \qquad ( E6 )$$

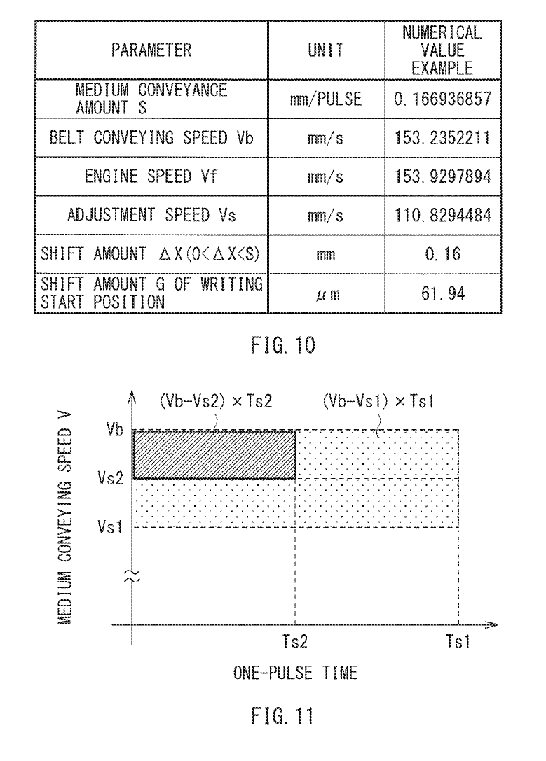

FIG. 10 illustrates an example of a result of calculation of the shift amount G of the writing start position. FIG. 10 describes the results of the calculations of the shift amount ΔX of the distance X and the shift amount G of the writing start position at a time when a medium conveyance amount S per pulse of the conveying motor 58, the belt conveying speed Vb, the engine speed Vf, and the adjustment speed Vs are set to the respective values described in FIG. 10. The image forming apparatus 100 may involve an occurrence of the shift in the writing start position as described above.

As can be appreciated from the expression (E5), it may be possible to reduce the shift amount G of the writing start position by causing the adjustment speed Vs to be closer to the engine speed Vf, for example. However, when the adjustment speed Vs is caused to be closer to the engine speed Vf, an adjustment amount per pulse of the conveying motor 58 may be reduced as described below.

FIG. 11 schematically illustrates the adjustment amount per pulse of the conveying motor 58 when the adjustment speed Vs is set to one of speeds Vs1 and Vs2. In FIG. 11, the horizontal axis may indicate a time per pulse, and the vertical axis may indicate the medium conveying speed V. The time per pulse may be referred to as a “one-pulse time”. The speed Vs2 may be higher than the speed Vs1 and be lower than the belt conveying speed Vb. Ts1 indicates one-pulse time in a case where the adjustment speed Vs is set to the speed Vs1. Ts2 indicates one-pulse time in a case where the adjustment speed Vs is set to the speed Vs2.

When the adjustment speed Vs is set to the speed Vs1, the adjustment amount per pulse may be expressed by “(Vb−Vs1)×Ts1”. When the adjustment speed Vs is set to the speed Vs2, the adjustment amount per pulse may be expressed by “(Vb−Vs2)×Ts2”. The foregoing adjustment amounts per pulse are expressed by the areas in FIG. 11. The adjustment amount per pulse may be smaller when the adjustment speed Vs is set to the higher speed Vs2 than when the adjustment speed Vs is set to the lower speed Vs1. There are two possible reasons for this. One reason may be that the one-pulse time of the stepper motor becomes shorter when the adjustment speed Vs is made closer to the engine speed Vf. Another reason may be that a difference between the engine speed Vf and the adjustment speed Vs may be smaller when the adjustment speed Vs is made closer to the engine speed Vf as indicated by the vertical axis in FIG. 11. Accordingly, the adjustment amount per pulse of the conveying motor 58 may be smaller as the adjustment speed Vs is closer to the engine speed Vf.

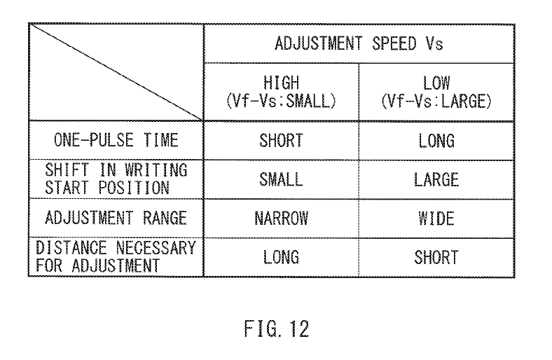

As described above, when the adjustment speed Vs is higher, the adjustment amount per pulse of the conveying motor 58 may be smaller, although the shift in the writing start position may be smaller. Accordingly, the adjustment range may be narrowed, or the medium conveyance distance that is necessary for the adjustment may be increased, as illustrated in FIG. 12. The adjustment distance D may be preferably in a range from about 15 mm to about 35 mm, for example, as described above. It is not preferable that the adjustment distance D be shorter than the foregoing range. Further, when the medium conveyance distance that is necessary for the adjustment is increased in order to cause the adjustment distance D to fall within the foregoing range, structural dimensions of the image forming apparatus 100 may be increased. Such an increase in the structural dimensions of the image forming apparatus 100 may not be preferable in terms of factors such as cost and usability.

In contrast, when the adjustment speed Vs is lower, it may be possible to increase the adjustment amount per pulse of the conveying motor 58. Accordingly, the adjustment range may be widened, or the medium conveying distance that is necessary for the adjustment may be reduced. However, when the adjustment speed Vs is lower, the shift in the writing start position may be increased. As described above, the shift in the writing start position and the adjustment range may have a so-called trade-off relationship with each other in the image forming apparatus 100, for example. Accordingly, it has been difficult to achieve both the preferable writing start position and the preferable adjustment range.

### 2. First Example Embodiment

An image forming apparatus 1 according to a first example embodiment of the technology is described below. The present example embodiment may be different from the foregoing reference example in a method of controlling the medium conveying speed V. It is to be noted that components that are substantially the same as those of the image forming apparatus 100 according to the foregoing reference example are denoted with the same numerals and will not be further described where appropriate.

### Configuration Example

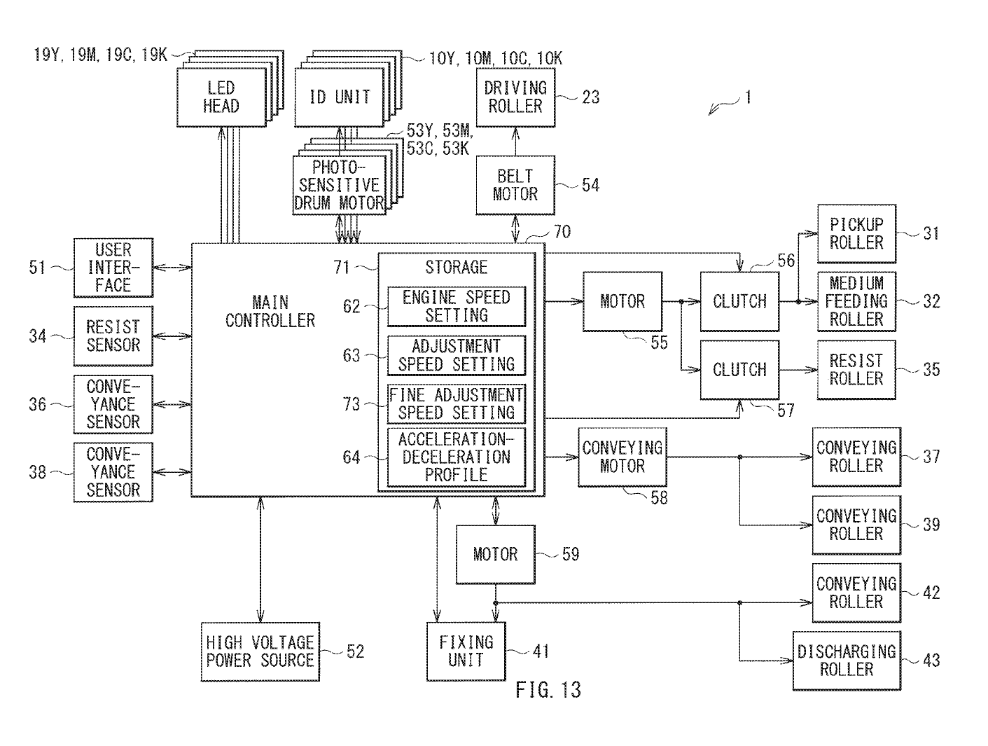

FIG. 13 illustrates an example of a control mechanism in the image forming apparatus 1. The image forming apparatus 1 includes a main controller 70. The main controller 70 may include a storage 71. The storage 71 may store the engine speed setting 62, the adjustment speed setting 63, a fine adjustment speed setting 73, and the acceleration-deceleration profile 64, in the present example.

The fine adjustment speed setting 73 may be setting data directed to setting the medium conveying speed V to a fine adjustment speed Vfa. Specifically, the fine adjustment speed setting 73 may include a setting value of a pulse width of the pulse signal to be supplied to the conveying motor 58 when the medium conveying speed V is set to the fine adjustment speed Vfa. The fine adjustment speed Vfa may be higher than the adjustment speed Vs and lower than the engine speed Vf. It is preferable that the fine adjustment speed Vfa be so set that a difference (Vf−Vfa) between the engine speed Vf and the fine adjustment speed Vfa is smaller than a difference (Vfa−Vs) between the fine adjustment speed Vfa and the adjustment speed Vs, for example.

The main controller 70 may control, on the basis of the results of the detection performed by the respective conveyance sensors 36 and 38, the medium conveying speed V with the engine speed setting 62, the adjustment speed setting 63, the fine adjustment speed setting 73, and the acceleration-deceleration profile 64 described above. Upon controlling the medium conveying speed V, the main controller 70 may perform coarse adjustment with the adjustment speed Vs, and perform fine adjustment with the fine adjustment speed Vfa. The main controller 70 may thus adjust the shift in the writing start position.

The intermediate transfer belt 22 may correspond to a “transfer belt” in one specific but non-limiting embodiment of the technology. The conveying rollers 37 and 39 and the conveying motor 58 may correspond to a “medium conveyer” in one specific but non-limiting embodiment of the technology. The main controller 70 may correspond to a “controller” in one specific but non-limiting embodiment of the technology. The engine speed Vf may correspond to a “first speed” in one specific but non-limiting embodiment of the technology. The adjustment speed Vs may correspond to a “second speed” in one specific but non-limiting embodiment of the technology. The fine adjustment speed Vfa may correspond to a “third speed” in one specific but non-limiting embodiment of the technology. The secondary transfer unit 30 may correspond to a “transfer unit” in one specific but non-limiting embodiment of the technology. The conveyance sensor 38 may correspond to a “first detector” in one specific but non-limiting embodiment of the technology. The conveyance sensor 36 may correspond to a “second detector” in one specific but non-limiting embodiment of the technology.

### [Operation and Workings]

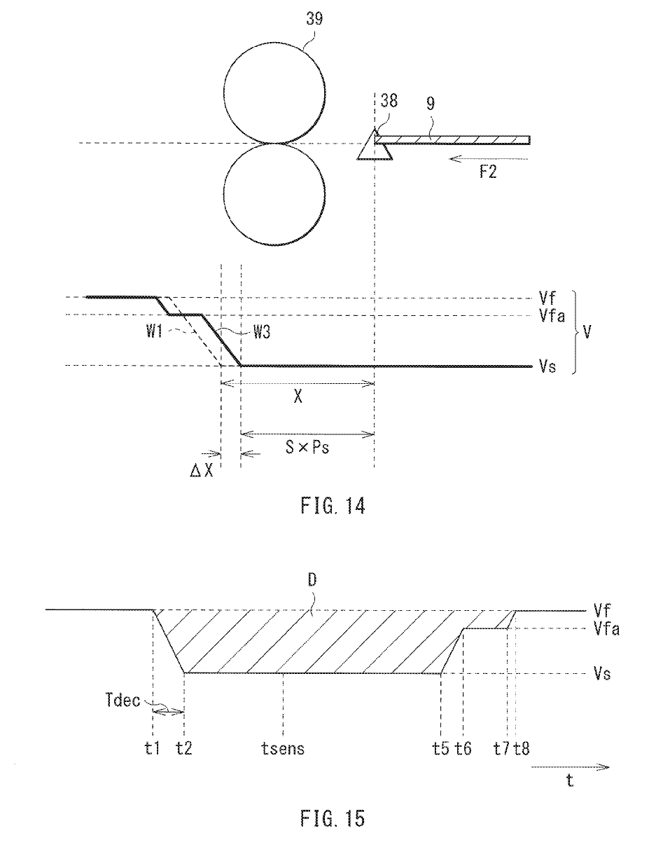

FIG. 14 illustrates an example of an operation of the image forming apparatus 1. FIG. 15 illustrates an example of a change in the medium conveying speed V on a time axis. In FIG. 14, characteristics W3 indicate an actual case of the image forming apparatus 1. It is to be noted that the characteristics W1 in FIG. 14 are the same as the characteristics W1 illustrated in FIG. 9.

The image forming apparatus 1 may first cause the recording medium 9 to precede the tone image on the intermediate transfer belt 22 by the adjustment distance D, as with the image forming apparatus 100 according to the foregoing reference example. Further, the main controller 70 may control the conveying motor 58, and thereby start to change (to decelerate) the medium conveying speed V of the recording medium 9 from the engine speed Vf to the adjustment speed Vs at the timing t1. The timing t1 may be the timing when the recording medium 9 has traveled by the distance Dsns1 after the first conveyance sensor 36 has detected the tip end of the recording medium 9. Thereafter, the medium conveying speed V may reach the adjustment speed Vs at the timing t2.

Thereafter, the second conveyance sensor 38 may detect the tip end of the recording medium 9 at the detection timing tsens in the period in which the recording medium 9 is conveyed at the adjustment speed Vs as illustrated in FIGS. 14 and 15. The main controller 70 may determine the distance X on the basis of the toner image conveyance distance Dimg at the detection timing tsens. Further, the main controller 70 may determine the fine adjustment pulse number Pa which will be described later. Further, the main controller 70 may control the conveying motor 58, and thereby start to change (to accelerate) the medium conveying speed V of the recording medium 9 from the adjustment speed Vs toward the fine adjustment speed Vfa at timing t5. The timing t5 may be timing when the recording medium 9 has traveled by a distance of (S×Ps) after the second conveyance sensor 38 has detected the tip end of the recording medium 9. Thereafter, the medium conveying speed V may reach the fine adjustment speed Vfa at timing t6. Further, the main controller 70 may control the conveying motor 58, and thereby start to change (to accelerate) the medium conveying speed V from the fine adjustment speed Vfa toward the engine speed Vf at timing t7. The timing t7 may depend on the fine adjustment pulse number Pa. Thereafter, the medium conveying speed V may reach the engine speed Vf at timing t8.

As described above, the image forming apparatus 1 may first set the medium conveying speed V to the adjustment speed Vs and thereby perform the coarse adjustment. Further, the image forming apparatus 1 may thereafter set the medium conveying speed V to the fine adjustment speed Vfa and thereby perform the fine adjustment.

Also, for the image forming apparatus 1, the distance X may be expressed by the expression (E2), and the pulse number Ps of the pulse signal to be supplied to the conveying motor 58 may be expressed by the expression (E3), as in the foregoing reference example. A description is given below of a case where the time difference Δt expressed by the expression (E5) in the foregoing reference example is made one-Nth (1/N) where N is a magnification of resolution. In this case, a relationship between the fine adjustment speed Vfa, the shift amount ΔX, the engine speed Vf, the adjustment speed Vs, and the magnification N of the resolution is expressed by the following expression.

$$\frac{Δ t}{N} = \frac{Δ X}{Vfa} - \frac{Δ X}{Vf} \qquad ( E7 )$$

The following expression is obtained by solving the expressions (E5) and (E7) for the fine adjustment speed Vfa.

$$Vfa = \frac{N \times Vs \times Vf}{Vf + ( N - 1 ) \times Vs} \qquad ( E8 )$$

A correction amount Xa per pulse of the conveying motor 58 in a case where the medium conveying speed V is the fine adjustment speed Vfa may be expressed by the following expression,

$$\begin{matrix}Xa = Vf \times Tfa - S \\ = Vf \times Tfa - Vfa \times Tfa\end{matrix} \qquad ( E9 )$$

where Tfa is a one-pulse time of the conveying motor 58 in the case where the medium conveying speed V is the fine adjustment speed Vfa. The first term on the right side of the foregoing expression (E9) expresses a conveyance amount of the recording medium 9 for one-pulse time in the case where the medium conveying speed V is the fine adjustment speed Vfa when the recording medium 9 is conveyed at the engine speed Vf despite the original intention. The second term on the right side of the foregoing expression (E9) expresses an actual conveyance amount of the recording medium 9 for one-pulse time in the case where the medium conveying speed V is the fine adjustment speed Vfa. The fine adjustment pulse number Pa may be expressed by the following expression (E10) with the correction amount Xa,

$$Pa = round ( \frac{G}{Xa} ) \qquad ( E10 )$$

where “round” is a function that performs a calculation of rounding to the whole number.

A shift amount G1 of the writing start position after the correction may be expressed by the following expression (E11) with the shift amount G of the writing start position determined by the expression (E6), the correction amount Xa per pulse determined by the expression (E9), and the fine adjustment pulse number Pa determined by the expression (E10).

G1=G−Xa×Pa (E11)

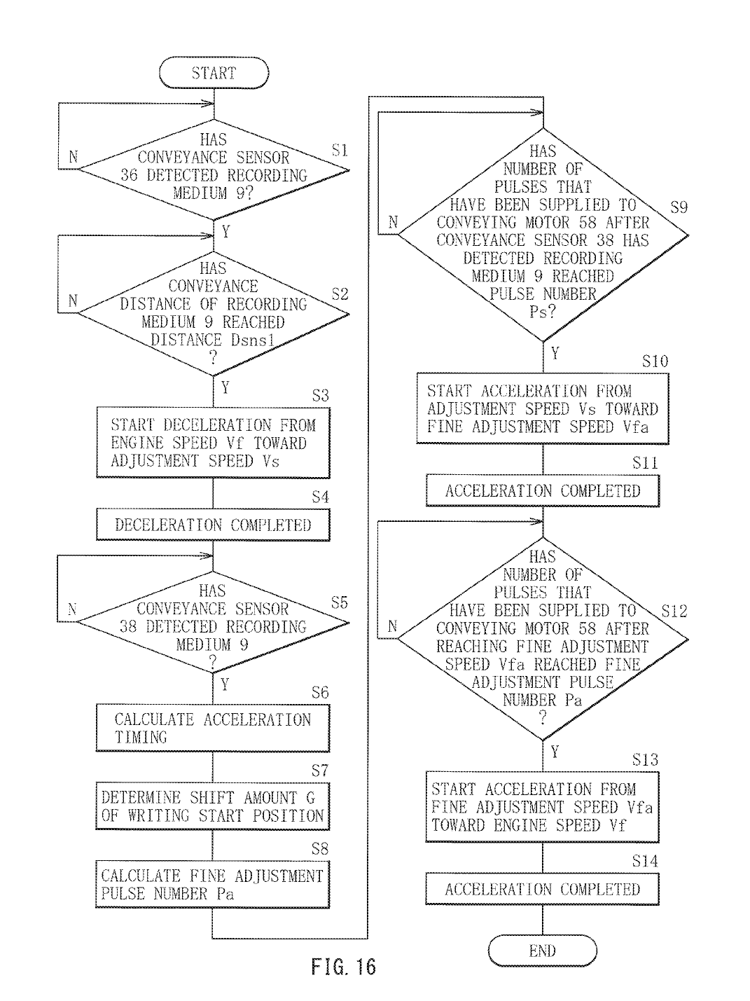

FIG. 16 illustrates an example of an operation of the main controller 70 in the image forming apparatus 1. The image forming apparatus 1 may first set the medium conveying speed V to the adjustment speed Vs and thereby perform the coarse adjustment. The image forming apparatus 1 may thereafter set the medium conveying speed V to the fine adjustment speed Vfa and thereby perform the fine adjustment. This operation is described below in detail.

First, the main controller 70 may confirm whether the first conveyance sensor 36 has detected the tip end of the recording medium 9 (step S1). When the conveyance sensor 36 has not detected the tip end of the recording medium 9 yet (“N” in step S1), the flow may return to step S1 and the process in step S1 may be repeated until the conveyance sensor 36 detects the tip end of the recording medium 9.

When the conveyance sensor 36 has detected the tip end of the recording medium 9 in step S1 (“Y” in step S1), the main controller 70 may confirm whether the conveyance distance of the recording medium 9 has reached the distance Dsns1 after the conveyance sensor 36 has detected the tip end of the recording medium 9 (step S2). Specifically, the main controller 70 may count the number of pulses supplied to the conveyance motor 58, and thereby determine the conveyance distance of the recording medium 9. Further, the main controller 70 may confirm whether the determined conveyance distance of the recording medium 9 has reached the distance Dsns1. When the conveyance distance of the recording medium 9 has not reached the distance Dsns1 yet (“N” in step S2), the flow may return to step S2, and the process in step S2 may be repeated until the conveyance distance of the recording medium 9 reaches the distance Dsns1.

When the conveyance distance of the recording medium 9 has reached the distance Dsns1 in step S2 (“Y” in step S2), the main controller 70 may control the conveying motor 58, and thereby start to change (to decelerate) the medium conveying speed V from the engine speed Vf toward the adjustment speed Vs (step S3). Thereafter, the medium conveying speed V may reach the adjustment speed Vs (step S4).

Thereafter, the main controller 70 may confirm whether the second conveyance sensor 38 has detected the tip end of the recording medium 9 (step S5). When the conveyance sensor 38 has not detected the tip end of the recording medium 9 yet (“N” in step S5), the flow may return to step S5, and the process in step S5 may be repeated until the conveyance sensor 38 detects the tip end of the recording medium 9.

When the conveyance sensor 38 has detected the tip end of the recording medium 9 in step S5 (“Y” in step S5), the main controller 70 may determine an acceleration timing (step S6). Specifically, the main controller 70 may determine the distance X with the expression (E2), and determine the pulse number Ps with the determined distance X and the expression (E3).

Thereafter, the main controller 70 may determine the shift amount G of the writing start position (step S7). Specifically, the main controller 70 may determine the shift amount ΔX of the distance X with the expression (E4), and determine the shift amount G of the writing start position with the determined shift amount ΔX and the expression (E6).

Thereafter, the main controller 70 may determine the fine adjustment pulse number Pa (step S8). Specifically, the main controller 70 may determine the fine adjustment pulse number Pa with the expressions (E9) and (E10).

Thereafter, the main controller 70 may confirm whether the number of the pulses that have been supplied to the conveying motor 58 after the second conveyance sensor 38 has detected the tip end of the recording medium 9 has reached the pulse number Ps (step S9). When the number of the pulses that have been supplied to the conveying motor 58 has not reached the pulse number Ps yet (“N” in step S9), the flow may return to step S9, and the process in step S9 may be repeated until the number of the pulses supplied to the conveying motor 58 reaches the pulse number Ps.

When the number of the pulses that have been supplied to the conveying motor 58 has reached the pulse number Ps in step S9 (“Y” in step S9), the main controller 70 may control the conveying motor 58, and thereby start to change (to accelerate) the medium conveying speed V from the adjustment speed Vs toward the fine adjustment speed Vfa (step S10). Thereafter, the medium conveying speed V may reach the fine adjustment speed Vfa (step S11).

Thereafter, the main controller 70 may confirm whether the number of the pulses that have been supplied to the conveying motor 58 after the medium conveying speed V has reached the fine adjustment speed Vfa has reached the fine adjustment pulse number Pa (step S12). When the number of the pulses that have been supplied to the conveying motor 58 has not reached the fine adjustment pulse number Pa yet (“N” in step S12), the flow may return to step S12, and the process in step S12 may be repeated until the number of the pulses supplied to the conveying motor 58 reaches the fine adjustment pulse number Pa.

When the number of the pulses that have been supplied to the conveying motor 58 has reached the fine adjustment pulse number Pa in step S12 (“Y” in step S12), the main controller 70 may control the conveying motor 58, and thereby start to change (to accelerate) the medium conveying speed V from the fine adjustment speed Vfa toward the engine speed Vf (step S13). Thereafter, the medium conveying speed V may reach the engine speed Vf (step S14).

This may bring the flow to the end.

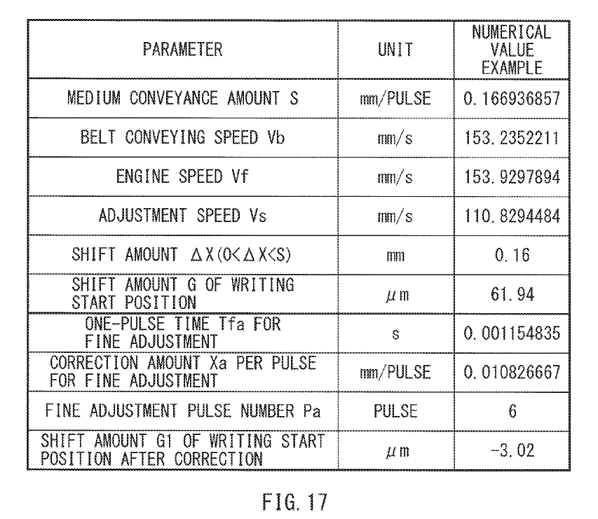

FIG. 17 illustrates an example of a result of a calculation of the shift amount G1 of the writing start position after the foregoing correction is performed. FIG. 17 describes the results of the calculations of the shift amount G1 of the writing start position after the correction, when the one-pulse time Tfa at the time of the fine adjustment, the correction amount Xa per pulse at the time of the fine adjustment, and the fine adjustment pulse number Pa are set to the respective values described in FIG. 17. The magnification N of the resolution may be set to “6” (N=6) in the present example. The image forming apparatus 1 may perform the fine adjustment as described above. It is therefore possible to make the shift amount G1 of the writing start position smaller than the shift amount G of the writing start position in the case without performing the fine adjustment.

Further, the image forming apparatus 1 may perform the coarse adjustment with the adjustment speed Vs and perform the fine adjustment with the fine adjustment speed Vfa. As a result, the image forming apparatus 1 may reduce the shift in the writing start position by the fine adjustment while maintaining the adjustment range by the coarse adjustment.

Moreover, as illustrated in FIG. 15, the image forming apparatus 1 may cause the second conveyance sensor 38 to detect the tip end of the recording medium 9 at the detecting timing tsens in the period in which the recording medium 9 is conveyed at the adjustment speed Vs. The image forming apparatus 1 may also perform the coarse adjustment and the fine adjustment on the basis of the toner image conveyance distance Dimg at the detecting timing tsens. The image forming apparatus 1 may thus allow for reduction in structural dimensions. Specifically, the detection of the recording medium 9 and the fine adjustment are performed separately from the coarse adjustment in the case where the coarse adjustment is performed in the period from the timing t1 to the timing t4, the medium conveying speed V is temporarily set to the engine speed Vf thereafter, another conveyance sensor detects the tip end of the recording medium 9, and the fine adjustment is performed on the basis of the result of the detection as illustrated in FIG. 8, for example. In such a case, the medium conveyance distance necessary for the adjustment may be increased. Such an increase in the medium conveyance distance necessary for the adjustment may result in an increase in structural dimensions of the image forming apparatus. In contrast, the image forming apparatus 1 may cause the conveyance sensor 38 to detect the recording medium 9 in the period in which the medium conveying speed V is set to the adjustment speed Vs, and perform the coarse adjustment and the fine adjustment on the basis of the result of the detection. This may allow for reduction in the medium conveyance distance necessary for the adjustment. As a result, the image forming apparatus 1 may allow for reduction in structural dimensions.

Particularly, the image forming apparatus 1 may change the medium conveying speed V directly from the adjustment speed Vs to the fine adjustment speed Vfa as illustrated in FIG. 15. This may allow the image forming apparatus 1 to perform the coarse adjustment and the fine adjustment together, therefore reducing the medium conveyance distance necessary for the adjustment. As a result, it may be possible to reduce structural dimensions.

### [Effects]

In the present example embodiment, the fine adjustment may be performed with the fine adjustment speed while the coarse adjustment is performed with the adjustment speed as described above. This makes it possible to reduce the shift in the writing start position by the fine adjustment while maintaining the adjustment range by the coarse adjustment.

In the present example embodiment, the second conveyance sensor may detect the recording medium in the period in which the recording medium is conveyed at the adjustment speed, and the coarse adjustment and the fine adjustment are performed on the basis of the result of the detection. This allows for reduction in medium conveyance distance necessary for the adjustment. As a result, it is possible to reduce the structural dimensions of the image forming apparatus.

In the present example embodiment, the medium conveying speed may be changed directly from the adjustment speed to the fine adjustment speed. This allows the coarse adjustment and the fine adjustment to be performed together. As a result, it is possible to reduce the structural dimensions of the image forming apparatus.

### [Modification 1-1]

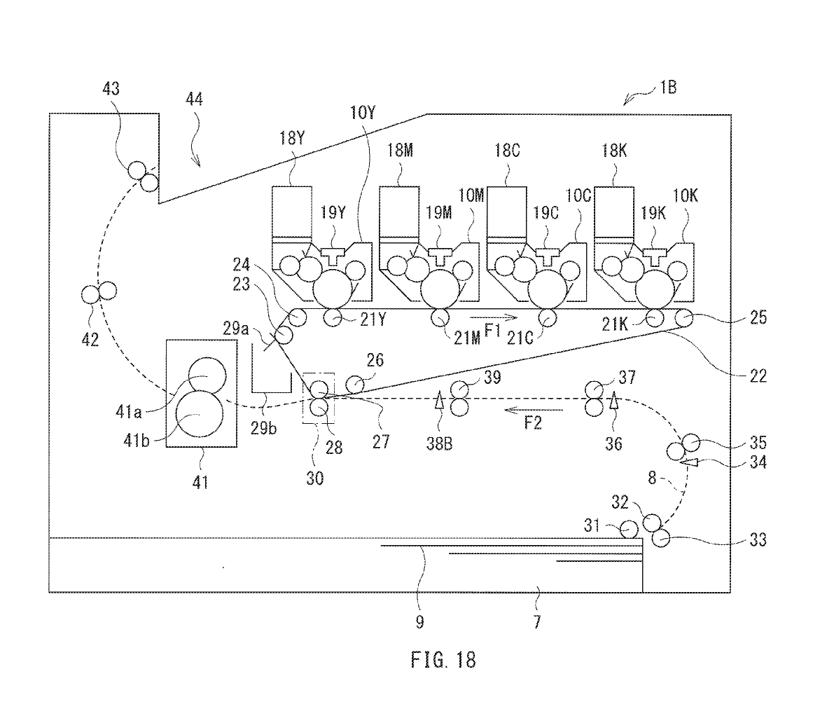

The conveyance sensor 38 may be provided upstream from the conveying roller 39 in the foregoing first example embodiment. However, the location of the conveyance sensor 38 is not limited thereto. Alternatively, a second conveyance sensor 38B may be provided downstream from the conveying roller 39 as in an image forming apparatus 1B illustrate in FIG. 18, for example. In this case, the recording medium 9 may be fed to the conveyance sensor 38B via the conveying roller 39, for example. This may suppress a warpage of the recording medium 9, therefore improving adjustment accuracy.

### 3. Second Example Embodiment

An image forming apparatus 2 according to a second example embodiment is described below. The second example embodiment is different from the foregoing first example embodiment in the method of setting the medium conveying speed V to the fine adjustment speed. It is to be noted that components that are substantially the same as those of the image forming apparatus 1 according to the foregoing first example embodiment, etc. are denoted with the same numerals and will not be further described where appropriate.

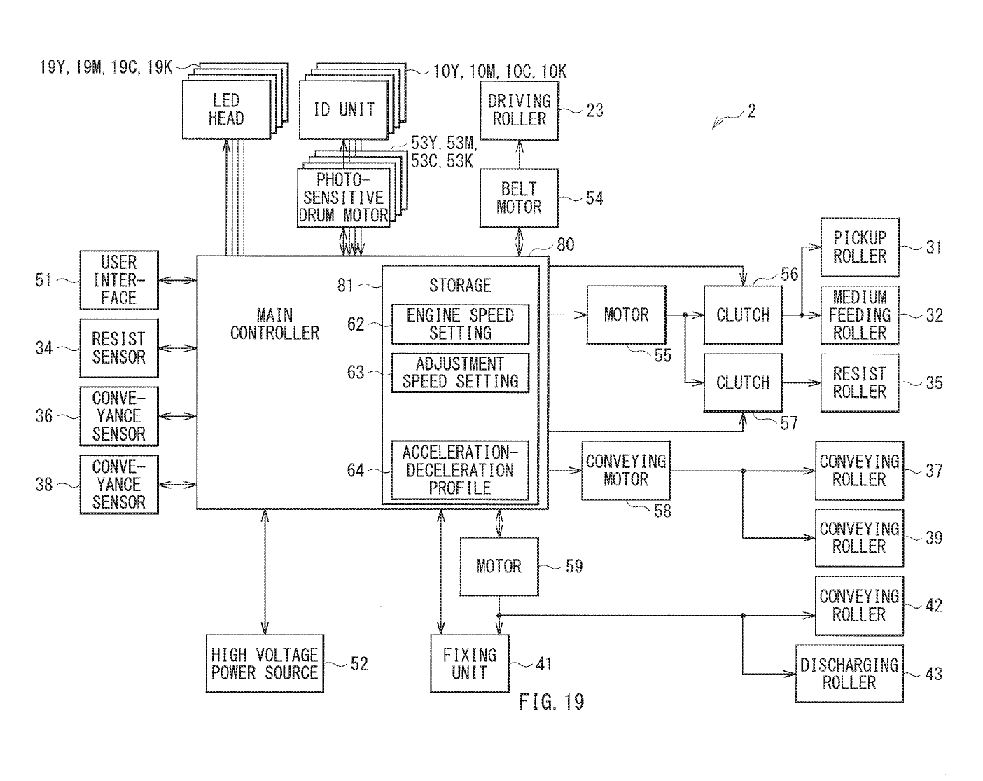

FIG. 19 illustrates an example of a control mechanism in the image forming apparatus 2 according to the second example embodiment. The image forming apparatus 2 includes a main controller 80. The main controller 80 may include storage 81. The storage 81 may store the engine speed setting 62, the adjustment speed setting 63, and the acceleration-deceleration profile 64, in the present example.

The main controller 80 may control, on the basis of the results of the detection performed by the respective conveyance sensors 36 and 38, the medium conveying speed V with the engine speed setting 62, the adjustment speed setting 63, and the acceleration-deceleration profile 64 described above. Upon controlling the medium conveying speed V, the main controller 80 may perform the coarse adjustment using the adjustment speed Vs, and perform the fine adjustment selectively using fine adjustment speeds Vfplus and Vfminus. The main controller 80 may thus adjust the shift in the writing start position. The fine adjustment speed Vfplus may be higher than the engine speed Vf. The fine adjustment speed Vfminus may be lower than the engine speed Vf.

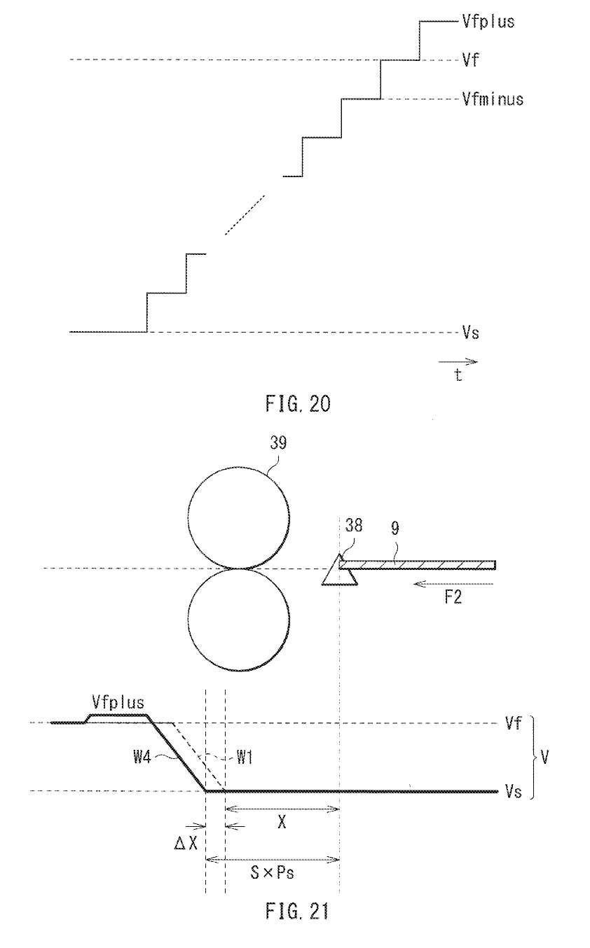

FIG. 20 illustrates an example of changing of the medium conveying speed V. The main controller 80 may change the medium conveying speed V in a stepwise manner with the acceleration-deceleration profile 64. The fine adjustment speed Vfplus may be a speed that is one step higher than the engine speed Vf in the acceleration-deceleration profile 64 in the present example. The fine adjustment speed Vfminus may be a speed that is one step lower than the engine speed Vf in the acceleration-deceleration profile 64 in the present example. It is to be noted that the fine adjustment speeds Vfplus and Vfminus are not limited to those described above. Alternatively, the fine adjustment speed Vfplus may be a speed that is higher than the engine speed Vf by predetermined steps, and the fine adjustment speed Vfminus may be a speed that is lower than the engine speed Vf by predetermined steps. This predetermined amount of steps may be preferably set in a range from about one step to about three steps for the sake of performing the fine adjustment, for example.

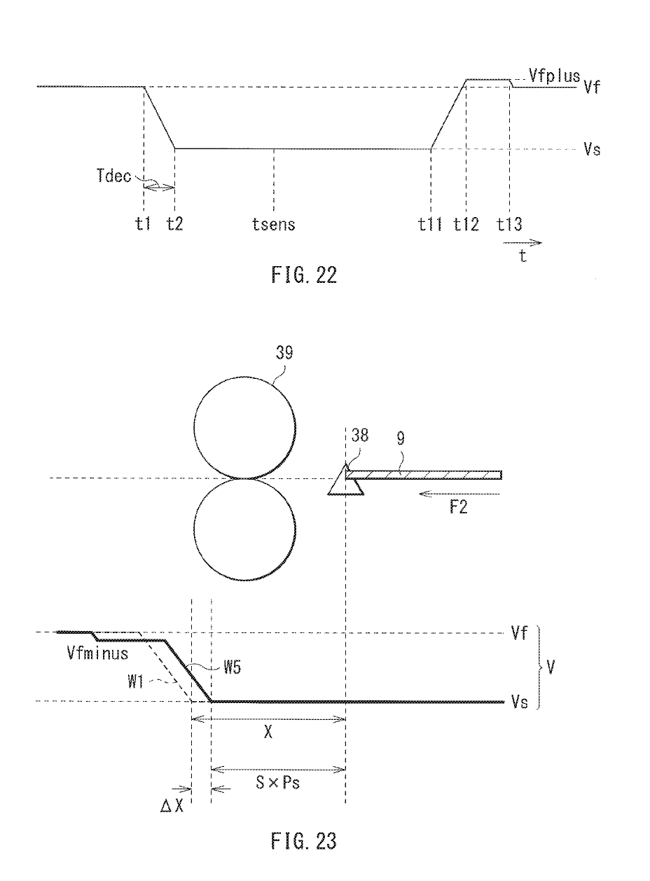

FIG. 21 illustrates an example of an operation of the image forming apparatus 2 performing the fine adjustment with the fine adjustment speed Vfplus. FIG. 22 illustrates an example of a change in the medium conveying speed V on a time axis in a case where the fine adjustment is performed with the fine adjustment speed Vfplus. In FIG. 21, characteristics W4 indicate an actual case of the image forming apparatus 2. An operation performed in a period from the timing t1 to the timing t2 may be similar to that in the foregoing first example embodiment.

The second conveyance sensor 38 may detect the tip end of the recording medium 9 at the detection timing tsens in the period in which the recording medium 9 is conveyed at the adjustment speed Vs as illustrated in FIGS. 21 and 22. The main controller 80 may determine the distance X on the basis of the toner image conveyance distance Dimg at the detection timing tsens. Further, the main controller 80 may determine the fine adjustment pulse number Pa2 which will be described later. Further, the main controller 80 may control the conveying motor 58, and thereby start to change (to accelerate) the medium conveying speed V of the recording medium 9 from the adjustment speed Vs toward the fine adjustment speed Vfplus at timing t11. The timing t11 may be timing when the recording medium 9 has traveled by a distance of (X×Ps) after the second conveyance sensor 38 has detected the tip end of the recording medium 9. Thereafter, the medium conveying speed V may reach the fine adjustment speed Vfplus at timing t12. Further, the main controller 80 may control the conveying motor 58, and thereby start to change (to decelerate) the medium conveying speed V from the fine adjustment speed Vfplus toward the engine speed Vf at timing t13. The timing t13 may depend on the fine adjustment pulse number Pa2. Thereafter, the medium conveying speed V may reach the engine speed Vf.

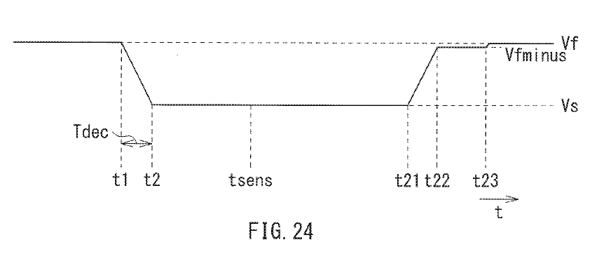

FIG. 23 illustrates an example of an operation of the image forming apparatus 2 performing the fine adjustment with the fine adjustment speed Vfminus FIG. 24 illustrates an example of a change in the medium conveying speed V on a time axis in the case where the fine adjustment is performed with the fine adjustment speed Vfminus. In FIG. 23, characteristics W5 indicate an actual case of the image forming apparatus 2.

The second conveyance sensor 38 may detect the tip end of the recording medium 9 at the detection timing tsens in the period in which the recording medium 9 is conveyed at the adjustment speed Vs as illustrated in FIGS. 23 and 24. The main controller 80 may determine the distance X on the basis of the toner image conveyance distance Dimg at the detection timing tsens. Further, the main controller 80 may determine the fine adjustment pulse number Pa2. Further, the main controller 80 may control the conveying motor 58, and thereby start to change (to accelerate) the medium conveying speed V of the recording medium 9 from the adjustment speed Vs toward the fine adjustment speed Vfminus at timing t21. The timing t21 may be timing when the recording medium 9 has traveled by a distance of (S×Ps) after the second conveyance sensor 38 has detected the tip end of the recording medium 9. Thereafter, the medium conveying speed V may reach the fine adjustment speed Vfminus at timing t22. Further, the main controller 80 may control the conveying motor 58, and thereby start to change (to accelerate) the medium conveying speed V from the fine adjustment speed Vfminus toward the engine speed Vf at timing t23. The timing t23 may depend on the fine adjustment pulse number Pa2. Thereafter, the medium conveying speed V may reach the engine speed Vf.

As described above, the image forming apparatus 2 may first set the medium conveying speed V to the adjustment speed Vs and thereby perform the coarse adjustment. Further, the image forming apparatus 2 may thereafter selectively set the medium conveying speed V to one of the fine adjustment speed Vfplus and the fine adjustment speed Vfminus and thereby perform the fine adjustment.

Also for the image forming apparatus 2, the distance X may be expressed by the expression (E2) as in the foregoing first example embodiment. Further, the main controller 80 may supply the conveying motor 58 with pulses of the pulse number Ps in order to cause the recording medium 9 to travel by the distance X. The pulse number Ps may be the number of pulses that is expressed by the following expression (E12), for example.

$$Ps = round ( \frac{X}{S} ) \qquad ( E12 )$$

Accordingly, the shift amount ΔX may be expressed by the following expression (E13).

$$Δ X = X - S \times Ps \\ ( - \frac{S}{2} - Δ X < \frac{S}{2} ) \qquad ( E13 )$$

When the shift amount ΔX of the distance X has a positive value (ΔX>0), the shift amount G of the writing start position may have a positive value (G>0). As a result, a margin on the tip end of the recording medium 9 may be increased. In this case, the main controller 80 may select the fine adjustment speed Vfminus. When the shift amount ΔX of the distance X has a negative value (ΔX<0), the shift amount G of the writing start position may have a negative value (G<0). As a result, the margin on the tip end of the recording medium 9 may be reduced. In this case, the main controller 80 may select the fine adjustment speed Vfplus.

The correction amount Xa per pulse of the conveying motor 58 may be expressed by the expression (E9) as in the foregoing first example embodiment. The fine adjustment speed Vfa in the expression (E9) may be the selected fine adjustment speed, which may be one of the fine adjustment speed Vfplus and the fine adjustment speed Vfminus. The fine adjustment pulse number Pa2 may be expressed by the following expression (E14) with this correction amount Xa,

$$Pa 2 = abs \{ round ( \frac{G}{Xa} ) \} \qquad ( E14 )$$

where “abs” is a function that performs a calculation of determining an absolute value. The shift amount G1 of the writing start position after the correction may be expressed by the expression (E11) as in the foregoing first example embodiment.

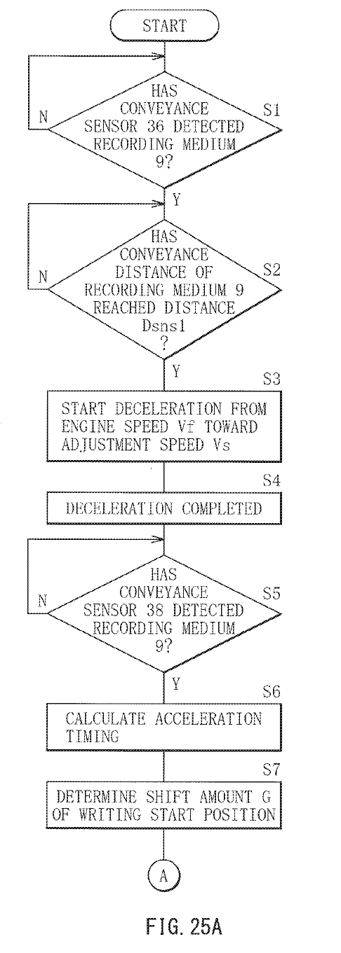

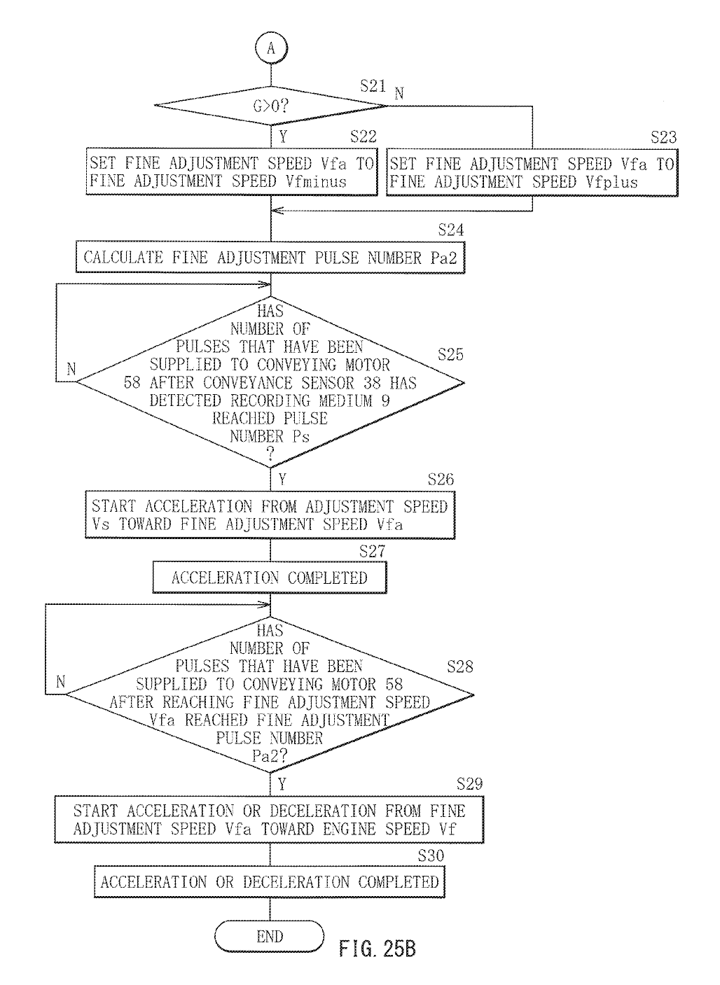

FIGS. 25A and 25B illustrate an example of an operation of the main controller 80 in the image forming apparatus 2. The image forming apparatus 2 may first set the medium conveying speed V to the adjustment speed Vs and thereby perform the coarse adjustment. Thereafter, the image forming apparatus 2 may selectively set the medium conveying speed V to one of the fine adjustment speed Vfplus and the fine adjustment speed Vfminus and thereby perform the fine adjustment. This operation is described below in detail.

First, the main controller 80 may control the conveying motor 58, and thereby start to change (to decelerate) the medium conveying speed V of the recording medium 9 from the engine speed Vf toward the adjustment speed Vs at timing when the recording medium 9 has traveled by the distance Dsns1 after the first conveyance sensor 36 has detected the tip end of the recording medium 9, as with the main controller 70 according to the first example embodiment (steps S1 to S3). Thereafter, the medium conveying speed V may reach the adjustment speed Vs (step S4). After the medium conveying speed V reaches the adjustment speed Vs, the main controller 80 may determine an acceleration timing on the basis of the toner image conveyance distance Dimg at the detection timing tsens when the second conveyance sensor 38 has detected the tip end of the recording medium 9, and thereby determine the shift amount G of the writing start position (steps S5 to S7). The acceleration timing may correspond to the distance X or the pulse number Ps (step S6).

Thereafter, the main controller 80 may confirm whether the shift amount G of the writing start position has a positive value (G>0) (step S21). When the shift amount G of the writing start position is a positive value (“Y” in step S21), the main controller 80 may set the fine adjustment speed Vfa to the fine adjustment speed Vfminus (step S22). In a case other than the case where the shift amount G of the writing start position is the positive value (“N” in step S21), the main controller 80 may set the fine adjustment speed Vfa to the fine adjustment speed Vfplus (step S23).

Thereafter, the main controller 80 may determine the fine adjustment pulse number Pa2 (step S24). Specifically, the main controller 80 may determine the fine adjustment pulse number Pa2 with the expressions (E9) and (E14).

Thereafter, the main controller 80 may confirm whether the number of the pulses that have been supplied to the conveying motor 58 has reached the pulse number Ps after the second conveyance sensor 38 has detected the tip end of the recording medium 9 (step S25). When the number of the pulses that have been supplied to the conveying motor 58 has not reached the pulse number Ps yet (“N” in step S25), the flow may return to step S25, and the process in step S25 may be repeated until the number of the pulses that have been supplied to the conveying motor 58 reaches the pulse number Ps.

When the number of the pulses that have been supplied to the conveying motor 58 has reached the pulse number Ps in step S25 (“Y” in step S25), the main controller 80 may control the conveying motor 58, and thereby start to change (to accelerate) the medium conveying speed V from the adjustment speed Vs toward the fine adjustment speed Vfa (step S26). This fine adjustment speed Vfa may be one of the fine adjustment speed Vfminus set in step S22 and the fine adjustment speed Vfplus set in step S23. Thereafter, the medium conveying speed V may reach the fine adjustment speed Vfa (step S27).

Thereafter, the main controller 80 may confirm whether the number of pulses that have been supplied to the conveying motor 58 after the medium conveying speed V has reached the fine adjustment speed Vfa has reached the fine adjustment pulse number Pa2 (step S28). When the number of the pulses that have been supplied to the conveying motor 58 has not reached the fine adjustment pulse number Pa2 yet (“N” in step S28), the flow may return to step S28, and the process in step S28 may be repeated until the number of the pulses that have been supplied to the conveying motor 58 reaches the fine adjustment pulse number Pa2.

When the number of the pulses that have been supplied to the conveying motor 58 has reached the fine adjustment pulse number Pa2 (“Y” in step S28), the main controller 80 may control the conveying motor 58, and thereby start to change (to accelerate or decelerate) the medium conveying speed V from the fine adjustment speed Vfa toward the engine speed Vf (step S29). Thereafter, the medium conveying speed V may reach the engine speed Vf (step S30).

This may bring the flow to the end.

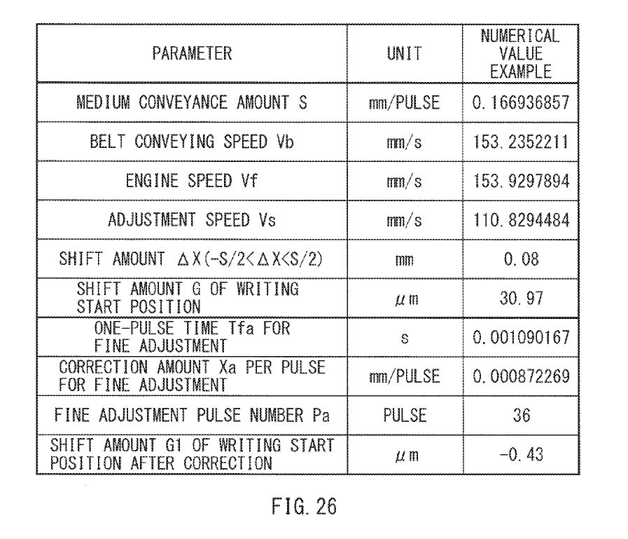

FIG. 26 illustrates an example of a result of calculation of the shift amount G1 of the writing start position after the foregoing correction is performed. The image forming apparatus 2 may perform the fine adjustment as described above. It is therefore possible to allow the shift amount G1 of the writing start position to be smaller than the shift amount G of the writing start position in the case without performing the fine adjustment.

Moreover, the image forming apparatus 2 may selectively set the fine adjustment speed Vfa to one of the speed one step higher than the engine speed Vf and the speed one step lower than the engine speed Vf. The speed one step higher than the engine speed Vf may be the fine adjustment speed Vfplus, and the speed one step lower than the engine speed Vf may be the fine adjustment speed Vfminus, for example. This makes it unnecessary for the storage 81 of the main controller 80 to store the fine adjustment speed setting, which is different from the storage 71 illustrated in FIG. 13 according to the first example embodiment. This allows for simplification of the configuration of the main controller 80.

As described above, in the second example embodiment, the fine adjustment speed may be selectively set to one of the speed one step higher than the engine speed and the speed one step lower than the engine speed. This makes it possible to simplify the configuration. Other effects may be similar to those in the foregoing first example embodiment.

### [Modification 2-1]

The conveyance sensor 38 may be provided upstream from the conveying roller 39 in the foregoing second example embodiment. However, the location of the conveyance sensor 38 is not limited thereto. Alternatively, the second conveyance sensor 38B may be provided downstream from the conveying roller 39 as in Modification 1-1 illustrated in FIG. 18 of the first example embodiment, for example.

### 4. Third Example Embodiment

An image forming apparatus 3 according to a third example embodiment is described below. According to the third example embodiment, the coarse adjustment and the fine adjustment may be performed on the basis of a result of detection performed by a single conveyance sensor. It is to be noted that components that are substantially the same as those of the image forming apparatus 1 according to the foregoing first example embodiment, etc. are denoted with the same numerals and will not be further described where appropriate.

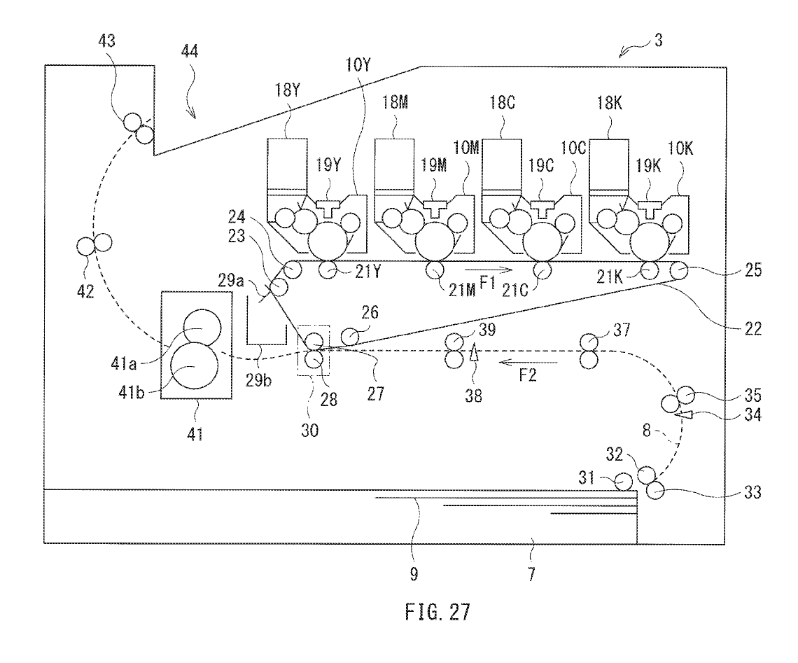

FIG. 27 illustrates an example of a configuration of the image forming apparatus 3 according to the third example embodiment. The image forming apparatus 3 may include the conveyance sensor 38. The conveyance sensor 38 may be used directed to adjustment of the shift in the writing start position on the recording medium 9 upon the transfer of the toner image onto the recording medium 9 performed by the secondary transfer unit 30. Specifically, the image forming apparatus 3 may perform the coarse adjustment and the fine adjustment on the basis of the result of the detection performed by the conveyance sensor 38. Specifically, the image forming apparatus 1 according to the foregoing first example embodiment performs the coarse adjustment on the basis of the result of the detection performed by the first conveyance sensor 36, and performs the fine adjustment on the basis of the result of the detection performed by the second conveyance sensor 38. In contrast, the image forming apparatus 3 may perform the coarse adjustment and the fine adjustment on the basis of the result of the detection performed by a single conveyance sensor, i.e., the conveyance sensor 38.

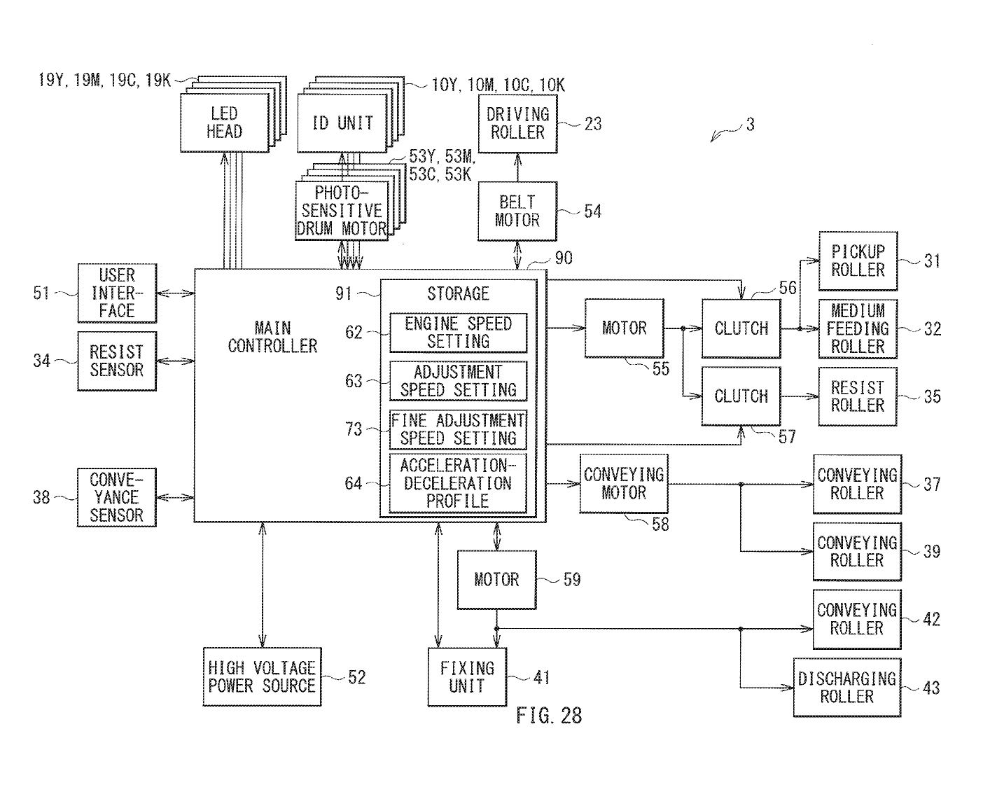

FIG. 28 illustrates an example of a control mechanism of the image forming apparatus 3. The image forming apparatus 3 includes a main controller 90. The main controller 90 may adjust, on the basis of the result of the detection performed by the conveyance sensor 38, the shift in the writing start position upon the transfer of the toner image onto the recording medium 9 by the secondary transfer unit 30. The main controller 90 may include a storage 91. The storage 91 may store the engine speed setting 62, the adjustment speed setting 63, the fine adjustment speed setting 73, and the acceleration-deceleration profile 64, as with the storage 71 according to the first example embodiment.

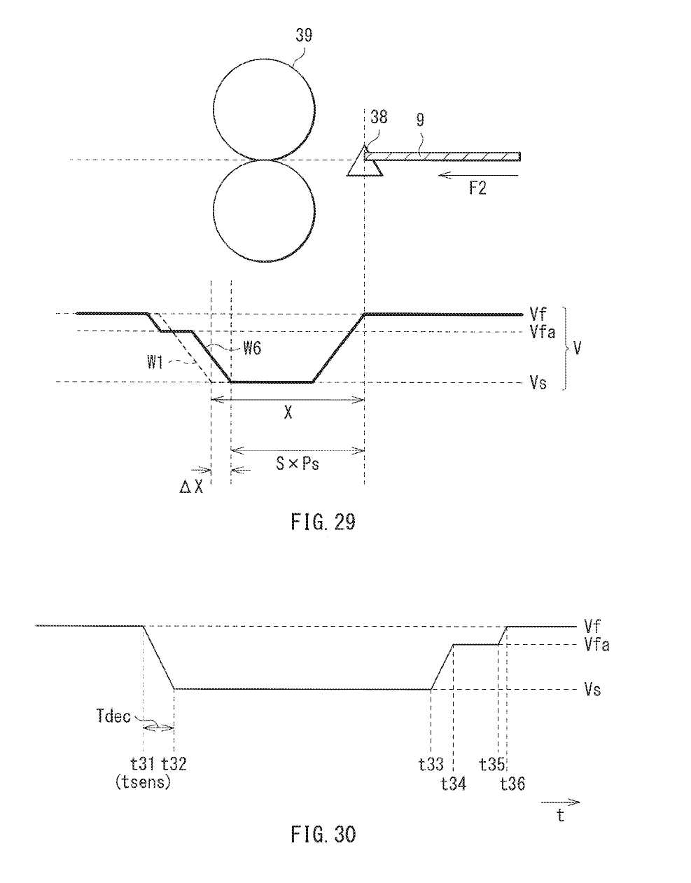

FIG. 29 illustrates an example of an operation of the image forming apparatus 3. FIG. 30 illustrates an example of a change in the medium conveying speed V on a time axis. In FIG. 29, characteristics W6 indicate an actual case of the image forming apparatus 3.

The image forming apparatus 3 may first cause the recording medium 9 to precede the toner image on the intermediate transfer belt 22 by the adjustment distance D as with the image forming apparatus 1 according to the first example embodiment, etc. Further, at timing t31, the conveyance sensor 38 may detect the tip end of the recording medium 9 that has been conveyed at the engine speed Vf as illustrated in FIGS. 29 and 30. In other words, the timing t31 may correspond to the detection timing tsens. The main controller 90 may control the conveying motor 58, and thereby start to change (to decelerate) the medium conveying speed V of the recording medium 9 from the engine speed Vf toward the adjustment speed Vs at this detection timing tsens. Thereafter, the medium conveying speed V may reach the adjustment speed Vs at the timing t2.

The main controller 90 may determine the distance X and the fine adjustment pulse number Pa on the basis of the toner image conveyance distance Dimg at the detection timing tsens. Further, the main controller 90 may control the conveying motor 58, and thereby start to change (to accelerate) the medium conveying speed V of the recording medium 9 from the adjustment speed Vs toward the fine adjustment speed Vfa at timing t33. The timing t33 may be timing when the recording medium 9 has traveled by the distance of (S×Ps) after the conveyance sensor 38 has detected the tip end of the recording medium 9. Thereafter, the medium conveying speed V may reach the fine adjustment speed Vfa at timing t34. Further, the main controller 90 may control the conveying motor 58, and thereby start to change (to accelerate) the medium conveying speed V from the fine adjustment speed Vfa toward the engine speed Vf at timing t35. The timing t35 may depend on the fine adjustment pulse number Pa. Thereafter, the medium conveying speed V may reach the engine speed Vf at timing t36.

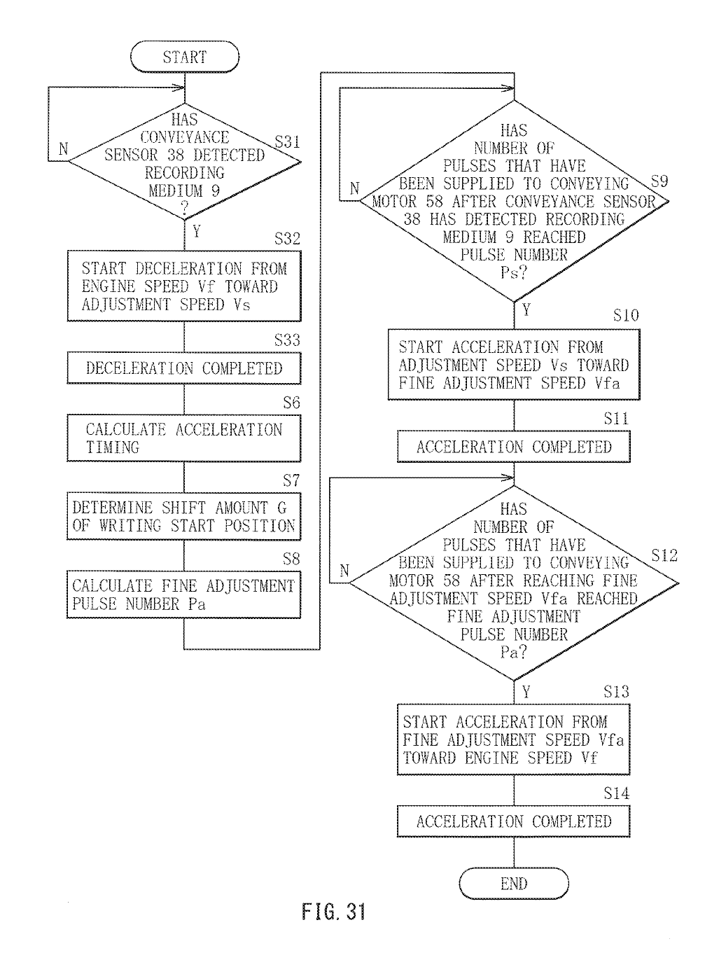

FIG. 31 illustrates an example of an operation of the main controller 90 in the image forming apparatus 3.

First, the main controller 90 may confirm whether the conveyance sensor 38 has detected the tip end of the recording medium 9 (step S31). When the conveyance sensor 38 has not detected the tip end of the recording medium 9 yet (“N” in step S31), the flow may return to step S31, and the process in step S31 may be repeated until the conveyance sensor 38 detects the tip end of the recording medium 9.

When the conveyance sensor 38 has detected the tip end of the recording medium 9 in step S31 (“Y” in step S31), the main controller 90 may control the conveying motor 58, and thereby start to change (to decelerate) the medium conveying speed V from the engine speed Vf toward the adjustment speed Vs (step S32). Thereafter, the medium conveying speed V may reach the adjustment speed Vs (step S33).

Thereafter, the main controller 90 may determine the acceleration timing as in the foregoing first example embodiment (step S6). Specifically, the main controller 90 may determine the distance X with the expression (E2), and determine the pulse number Ps with the determined distance X and the expression (E3).

Thereafter, the main controller 90 may determine the shift amount G of the writing start position as in the foregoing first example embodiment (step S7). Specifically, the main controller 90 may determine the shift amount ΔX of the distance X with the expression (E4), and determine the shift amount G of the writing start position with the determined shift amount ΔX and the expression (E6).

Thereafter, the main controller 90 may determine the fine adjustment pulse number Pa as in the foregoing first example embodiment (step S8). Specifically, the main controller 90 may determine the fine adjustment pulse number Pa with the expressions (E9) and (E10).

It is to be noted that the calculations are performed in steps S6 to S8 after the deceleration has completed in step S33 for the sake of convenience in description. However, this is not limitative. These calculations may be performed at any time after the conveyance sensor 38 has detected the tip end of the recording medium 9 in step S31.

Thereafter, the main controller 90 may start to change (to accelerate) the medium conveying speed V from the adjustment speed Vs toward the fine adjustment speed Vfa at timing when the number of the pulses that have been supplied to the conveying motor 58 after the conveyance sensor 38 has detected the tip end of the recording medium 9 reaches the pulse number Ps, as in the first example embodiment (steps S9 and S10). Thereafter, the medium conveying speed V may reach the fine adjustment speed Vfa (step S11).

Further, the main controller 90 may start to change (to accelerate) the medium conveying speed V from the fine adjustment speed Vfa toward the engine speed Vf at timing when the number of the pulses that have been supplied to the conveying motor 58 after the medium conveying speed V has reached the fine adjustment speed Vfa reaches the fine adjustment pulse number Pa, as in the foregoing first example embodiment (steps S12 and S13). Thereafter, the medium conveying speed V may reach the engine speed Vf (step S14).

This may bring the flow to the end.

As described above, it is possible to achieve effects similar to those in the foregoing first example embodiment by performing the coarse adjustment and the fine adjustment on the basis of the result of the detection performed by the single conveyance sensor 38.

### [Modification 3-1]

In the foregoing third example embodiment, the coarse adjustment and the fine adjustment may be performed on the basis of the result of the detection performed by the single conveyance sensor 38, using the configuration of the image forming apparatus 1 according to the first example embodiment. However, the configuration to be used is not limited thereto. Alternatively, for example, the coarse adjustment and the fine adjustment may be performed on the basis of the result of the detection performed by the single conveyance sensor 38, using the configuration of the image forming apparatus 2 according to the second example embodiment.

### [Modification 3-2]

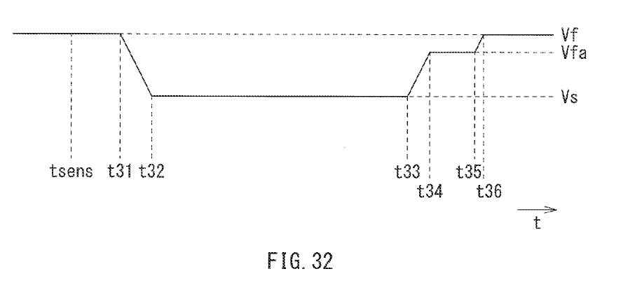

In the foregoing third example embodiment, the medium conveying speed V may start changing (decelerating) from the engine speed Vf toward the adjustment speed Vs on the basis on the result of the detection performed by the conveyance sensor 38. Upon the changing of the medium conveying speed V, the medium conveying speed V may start changing (decelerating) from the engine speed Vf toward the adjustment speed Vs after a predetermined time period elapses from the detection timing tsens as illustrated in FIG. 32, for example.

The technology is described above referring to some example embodiments and the modifications thereof. However, the technology is not limited to the example embodiments and the modifications described above, and may be variously modified.

The example embodiments and the modifications thereof described above each refer to the example case where the technology is applied to an image forming apparatus. However, this is not limitative. The technology may be applied to a so-called multi-function peripheral (MFP) having functions of a copier, a facsimile, a scanner, etc., for example.

Moreover, the foregoing example embodiments and the modifications thereof described above each refer to the example case where the image forming apparatus is able to form a color image. However, this is not limitative. The technology is also applicable to an image forming apparatus that is able to form a monochrome image.

Furthermore, the invention encompasses any possible combination of some or all of the various embodiments and the modifications described herein and incorporated herein.

It is possible to achieve at least the following configurations from the above-described example embodiments of the invention.

(1)
An image forming apparatus including:
a transfer belt that conveys a developer image at a predetermined belt conveying speed;
a medium conveyer that conveys a recording medium along a conveying path at a medium conveying speed;
a controller that sets the medium conveying speed to a first speed in a first period, to a second speed in a second period that is after the first period, to a third speed in a third period that is after the second period, and to the first speed in a fourth period that is after the third period, the first speed corresponding to the belt conveying speed, the second speed being lower than the first speed, the third speed being higher than the second speed and different from the first speed;
a transfer unit that transfers the developer image conveyed by the transfer belt onto the recording medium conveyed by the medium conveyer; and
a first detector that is provided upstream from the transfer unit in the conveying path, and performs detection of the recording medium in one of the first period and the second period,
the controller setting a length of the third period on a basis of a result of the detection performed by the first detector.
   (2)
The image forming apparatus according to (1), wherein the third speed is higher than the second speed and lower than the first speed.
   (3)
The image forming apparatus according to (2), wherein a difference between the third speed and the first speed is smaller than a difference between the third speed and the second speed.
   (4)
The image forming apparatus according to (1), wherein the controller selects, as the third speed, one of two speeds on the basis of the result of the detection performed by the first detector, the two speeds having the first speed in between.
   (5)
The image forming apparatus according to (4), wherein
the medium conveyer includes a stepper motor,
the controller sets the medium conveying speed in predetermined speed units, and
one of the two speeds having the first speed in between is higher than the first speed by a first step, and the other of the two speeds having the first speed in between is lower than the first speed by a second step.
   (6)
The image forming apparatus according to (5), wherein the first step and the second step are equal to each other.
   (7)
The image forming apparatus according to (5) or (6), wherein each of the first step and the second step is in a range from one step to three steps both inclusive.
   (8)
The image forming apparatus according to any one of (1) to (7), wherein the controller changes the medium conveying speed directly from the second speed to the third speed.
   (9)
The image forming apparatus according to any one of (1) to (8), wherein the controller changes, on the basis of the result of the detection performed by the first detector, the medium conveying speed from the second speed set in the second period to the third speed set in the third period.
   (10)
The image forming apparatus according to any one of (1) to (9), further including a second detector that is provided upstream from the first detector in the conveying path, and performs detection of the recording medium in the first period, wherein
the controller changes, on a basis of a result of the detection performed by the second detector, the medium conveying speed from the first speed set in the first period to the second speed set in the second period.
   (11)
The image forming apparatus according to (10), wherein the first detector detects the recording medium in the second period.
   (12)
The image forming apparatus according to any one of (1) to (9), wherein
the first detector performs the detection of the recording medium in the first period, and
the controller changes, on the basis of the result of the determination performed by the first detector, the medium conveying speed from the first speed set in the first period to the second speed set in the second period.
   (13)
A method of controlling conveyance, the method including:
conveying, with a transfer belt, a developer image at a predetermined belt conveying speed;
setting a medium conveying speed at which a recording medium is conveyed to a first speed in a first period, to a second speed in a second period that is after the first period, to a third speed in a third period that is after the second period, and to the first speed in a fourth period that is after the third period, the first speed corresponding to the belt conveying speed, the second speed being lower than the first speed, the third speed being higher than the second speed and different from the first speed;
conveying the recording medium along a conveying path at the medium conveying speed;
performing, in one of the first period and the second period, detection of the recording medium conveyed along the conveying path;
setting a length of the third period on a basis of a result of the detection of the recording medium; and
transferring the developer image conveyed by the transfer belt onto the recording medium conveyed along the conveying path.

According to the image forming apparatus and the method of controlling conveyance of one example embodiment of the technology, the medium conveying speed is set to a first speed in a first period, to a second speed in a second period that is after the first period, to a third speed in a third period that is after the second period, and to the first speed in a fourth period that is after the third period. The second speed is lower than the first speed. The third speed is higher than the second speed and different from the first speed. Further, the recording medium conveyed along the conveying path is detected in one of the first period and the second period. Further, a length of the third period is set on the basis of a result of the detection. As a result, it is possible to suppress a shift in a writing start position.

Although the technology has been described in terms of exemplary embodiments, it is not limited thereto. It should be appreciated that variations may be made in the described embodiments by persons skilled in the art without departing from the scope of the invention as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. The term “substantially” and its variations are defined as being largely but not necessarily wholly what is specified as understood by one of ordinary skill in the art. The term “about” or “approximately” as used herein can allow for a degree of variability in a value or range. Moreover, no element or component in this disclosure is intended to be dedicated to the public regardless of whether the element or component is explicitly recited in the following claims.

What is claimed is:

1. An image forming apparatus comprising:
a transfer belt that conveys a developer image at a predetermined belt conveying speed;
a medium conveyer that conveys a recording medium along a conveying path at a medium conveying speed;
a controller that sets the medium conveying speed to a first speed in a first period, to a second speed in a second period that is after the first period, to a third speed in a third period that is after the second period, and to the first speed in a fourth period that is after the third period, the first speed corresponding to the belt conveying speed, the second speed being lower than the first speed, the third speed being higher than the second speed and different from the first speed;
a transfer unit that transfers the developer image conveyed by the transfer belt onto the recording medium conveyed by the medium conveyer; and
a first detector that is provided upstream from the transfer unit in the conveying path, and performs detection of the recording medium in one of the first period and the second period,
the controller setting a length of the third period on a basis of a result of the detection performed by the first detector.

2. The image forming apparatus according to claim 1, wherein the third speed is higher than the second speed and lower than the first speed.

3. The image forming apparatus according to claim 2, wherein a difference between the third speed and the first speed is smaller than a difference between the third speed and the second speed.

4. The image forming apparatus according to claim 1, wherein the controller selects, as the third speed, one of two speeds on the basis of the result of the detection performed by the first detector, the two speeds having the first speed in between.

5. The image forming apparatus according to claim 4, wherein
the medium conveyer includes a stepper motor,
the controller sets the medium conveying speed in predetermined speed units, and
one of the two speeds having the first speed in between is higher than the first speed by a first step, and the other of the two speeds having the first speed in between is lower than the first speed by a second step.

6. The image forming apparatus according to claim 5, wherein the first step and the second step are equal to each other.

7. The image forming apparatus according to claim 5, wherein each of the first step and the second step is in a range from one step to three steps both inclusive.

8. The image forming apparatus according to claim 1, wherein the controller changes the medium conveying speed directly from the second speed to the third speed.

9. The image forming apparatus according to claim 1, wherein the controller changes, on the basis of the result of the detection performed by the first detector, the medium conveying speed from the second speed set in the second period to the third speed set in the third period.

10. The image forming apparatus according to claim 1, further comprising a second detector that is provided upstream from the first detector in the conveying path, and performs detection of the recording medium in the first period, wherein
the controller changes, on a basis of a result of the detection performed by the second detector, the medium conveying speed from the first speed set in the first period to the second speed set in the second period.

11. The image forming apparatus according to claim 10, wherein the first detector detects the recording medium in the second period.

12. The image forming apparatus according to claim 1, wherein
the first detector performs the detection of the recording medium in the first period, and
the controller changes, on the basis of the result of the determination performed by the first detector, the medium conveying speed from the first speed set in the first period to the second speed set in the second period.

13. A method of controlling conveyance, the method comprising:
conveying, with a transfer belt, a developer image at a predetermined belt conveying speed;
setting a medium conveying speed at which a recording medium is conveyed to a first speed in a first period, to a second speed in a second period that is after the first period, to a third speed in a third period that is after the second period, and to the first speed in a fourth period that is after the third period, the first speed corresponding to the belt conveying speed, the second speed being lower than the first speed, the third speed being higher than the second speed and different from the first speed;
conveying the recording medium along a conveying path at the medium conveying speed;
performing, in one of the first period and the second period, detection of the recording medium conveyed along the conveying path;
setting a length of the third period on a basis of a result of the detection of the recording medium; and
transferring the developer image conveyed by the transfer belt onto the recording medium conveyed along the conveying path.
